(19) United States
(12) Patent Application Publication
(10) Pub. No.: US 2011/0010626 A1
(43) Pub. Date: Jan. 13, 2011

(54) Device and Method for Adjusting a Playback Control with a Finger Gesture

(76) Inventors: Jorge Fino, San Jose, CA (US); Benjamin Andrew Rottler, San Francisco, CA (US); Policarpo Wood, San Francisco, CA (US)

Correspondence Address: Morgan Lewis & Bockius LLP/ AI, 2 Palo Alto Square, 3000 El Camino Real, Suite 700, Palo Alto, CA, 94306, US

(21) Appl. No.: 12/500,572

(22) Filed: Jul. 9, 2009

(51) Int. Cl. G06F 3/041; G06F 3/16

(52) U.S. Cl. 715/727; 345/173; 715/863

(57) ABSTRACT

In some embodiments, a method is performed at an electronic device with a touch-sensitive surface while the device is providing content. The device detects a finger contact at a first location on the surface. The first location and an edge of the surface define a first distance. The finger contact at the first location corresponds to a start of a control adjustment gesture for setting an adjustable parameter for providing content. In response to detecting the start of the control adjustment gesture, the device maps a range of positions associated with the adjustable parameter to correspond to at least a portion of the first distance; detects movement of the finger contact in the control adjustment gesture; and modifies the adjustable parameter for providing content in accordance with the movement of the finger contact in the control adjustment gesture and the mapping of the range of positions.

### TECHNICAL FIELD

The disclosed embodiments relate generally to electronic devices with touch-sensitive surfaces that provide media content (e.g., music and/or video content). More particularly, the disclosed embodiments relate to adjusting a playback control with a finger gesture on a touch-sensitive surface of an electronic device.

### BACKGROUND

The use of touch-sensitive surfaces as input devices for computers and other electronic computing devices has increased significantly in recent years. Exemplary touch-sensitive surfaces include touch pads and touch screen displays. Such surfaces are widely used to manipulate content that is provided on electronic devices.

Concurrently, electronic devices for providing or playing media content, including video, television programs, movies, etc., as well as audio recordings of all types (e.g., podcasts, music, lectures, audio-books, etc.) have become quite popular in recent years. These devices generally include controls to adjust content playback parameters such as volume, balance, treble, bass, screen brightness, etc. Sometimes these controls are physical buttons on the electronic device. Sometimes these controls are displayed on a screen, such as a touch screen display. Playback controls may be adjusted in a number of different ways, e.g., with physical buttons, via direct manipulation of the control on a touch screen, etc.

But existing methods for adjusting playback controls are cumbersome and inefficient. For example, navigating and manipulating a large number of playback controls, menus, or options is tedious and creates a significant cognitive burden on a user, particularly for handheld electronic devices. In addition, existing methods take longer than necessary, thereby wasting energy. This latter consideration is particularly important in battery-operated devices.

Accordingly, there is a need for electronic devices with faster, more efficient methods and interfaces for adjusting playback parameters on electronic devices. Such methods and interfaces may complement or replace existing playback control methods. Such methods and interfaces reduce the cognitive burden on a user and produce a more efficient human-machine interface. For battery-operated devices, such methods and interfaces conserve power and increase the time between battery charges.

### SUMMARY

The above deficiencies and other problems associated with user interfaces for electronic devices with touch-sensitive surfaces are reduced or eliminated by the disclosed devices. In some embodiments, the device is a desktop computer. In some embodiments, the device is portable (e.g., a notebook computer or handheld device). In some embodiments, the device has a touchpad. In some embodiments, the device has a touch-sensitive display (also known as a “touch screen” or “touch screen display”). In some embodiments, the device has a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive surface. In some embodiments, the functions may include one or more of: image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a computer readable storage medium or other computer program product configured for execution by one or more processors.

In accordance with some embodiments, a method is performed at an electronic device with a touch-sensitive surface while the device is providing content. The method includes detecting a finger contact at a first location on the touch-sensitive surface. The first location and a first edge of the touch-sensitive surface define a first distance. The finger contact at the first location corresponds to a start of a control adjustment gesture operable to set an adjustable parameter for providing content with the electronic device. The adjustable parameter is configured to be set to a position within a range of positions. In response to detecting the start of the control adjustment gesture at the first location, the method includes mapping the range of positions associated with the adjustable parameter to correspond to at least a portion of the first distance; detecting movement of the finger contact in the control adjustment gesture; and modifying the adjustable parameter for providing content in accordance with the movement of the finger contact in the control adjustment gesture and in accordance with the mapped range of positions associated with the adjustable parameter that correspond to the first distance.

In accordance with some embodiments, an electronic device includes a touch-sensitive surface, one or more processors, memory, and one or more programs. The one or more programs are stored in the memory and configured to be executed by the one or more processors. The one or more programs include instructions for detecting a finger contact at a first location on the touch-sensitive surface while providing content at the electronic device. The first location and a first edge of the touch-sensitive surface defines a first distance. The finger contact at the first location corresponds to a start of a control adjustment gesture operable to set an adjustable parameter for providing content with the electronic device. The adjustable parameter is configured to be set to a position within a range of positions. The one or more programs also include instructions for: mapping the range of positions associated with the adjustable parameter to correspond to the first distance in response to detecting the start of the control adjustment gesture at the first location; detecting movement of the finger contact in the control adjustment gesture; and modifying the adjustable parameter for providing content in accordance with the movement of the finger contact in the control adjustment gesture and in accordance with the mapped range of positions associated with the adjustable parameter that correspond to the first distance.

In accordance with some embodiments, a computer readable storage medium has stored therein instructions which when executed by an electronic device with a touch-sensitive surface, cause the device to detect a finger contact at a first location on the touch-sensitive surface while providing content with the electronic device. The first location and a first edge of the touch-sensitive surface defines a first distance. The finger contact at the first location corresponds to a start of a control adjustment gesture operable to set an adjustable parameter for providing content with the electronic device. The adjustable parameter is configured to be set to a position within a range of positions. The computer readable storage medium also has stored therein instructions which when executed cause the device to: map the range of positions associated with the adjustable parameter to correspond to the first distance in response to detecting the start of the control adjustment gesture at the first location; detect movement of the finger contact in the control adjustment gesture; and modify the adjustable parameter for providing content in accordance with the movement of the finger contact in the control adjustment gesture and in accordance with the mapped range of positions associated with the adjustable parameter that correspond to the first distance.

In accordance with some embodiments, an electronic device includes a touch-sensitive surface and means for providing content. The electronic device also includes means for detecting a finger contact at a first location on the touch-sensitive surface while the electronic device is providing content. The first location and a first edge of the touch-sensitive surface defines a first distance. The finger contact at the first location corresponds to a start of a control adjustment gesture operable to set an adjustable parameter for providing content with the electronic device. The adjustable parameter is configured to be set to a position within a range of positions. The electronic device also includes: means for mapping the range of positions associated with the adjustable parameter to correspond to the first distance in response to detecting the start of the control adjustment gesture at the first location; means for detecting movement of the finger contact in the control adjustment gesture; and means for modifying the adjustable parameter for providing content in accordance with the movement of the finger contact in the control adjustment gesture and in accordance with the mapped range of positions associated with the adjustable parameter that correspond to the first distance.

Thus, electronic devices with touch-sensitive surfaces are provided with faster, more efficient methods and interfaces for adjusting playback controls, thereby increasing the effectiveness, efficiency, and user satisfaction with such devices. Such methods and interfaces may complement or replace existing methods for adjusting parameters that control content playback.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIGS. 1A and 1B are block diagrams illustrating portable multifunction devices with touch-sensitive displays in accordance with some embodiments.

FIG. 2 illustrates a portable multifunction device having a touch screen in accordance with some embodiments.

FIG. 3 is a block diagram of an exemplary computing device with a display and a touch-sensitive surface in accordance with some embodiments.

FIGS. 4A and 4B illustrate exemplary user interfaces for a menu of applications on a portable multifunction device in accordance with some embodiments.

FIGS. 5A-5N illustrate exemplary user interfaces for adjusting a playback control with a finger gesture in accordance with some embodiments.

FIGS. 6A-6B are flow diagrams illustrating a method of adjusting a playback control with a finger gesture in accordance with some embodiments.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of computing devices, user interfaces for such devices, and associated processes for using such devices are described. In some embodiments, the computing device is a portable communications device such as a mobile telephone that also contains other functions, such as PDA and/or music player functions. Exemplary embodiments of portable multifunction devices include, without limitation, the iPhone® and iPod Touch° devices from Apple Inc. of Cupertino, Calif.

In the discussion that follows, a computing device that includes a display and a touch-sensitive surface is described. It should be understood, however, that the computing device may include one or more other physical user-interface devices, such as a physical keyboard, a mouse and/or a joystick.

The device supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that may be executed on the device may use at least one common physical user-interface device, such as the touch-sensitive surface. One or more functions of the touch-sensitive surface as well as corresponding information displayed on the device may be adjusted and/or varied from one application to the next and/or within a respective application. In this way, a common physical architecture (such as the touch-sensitive surface) of the device may support the variety of applications with user interfaces that are intuitive and transparent.

The user interfaces may include one or more soft keyboard embodiments. The soft keyboard embodiments may include standard (QWERTY) and/or non-standard configurations of symbols on the displayed icons of the keyboard, such as those described in U.S. patent applications Ser. No. 11/459,606, “Keyboards For Portable Electronic Devices,” filed Jul. 24, 2006, and U.S. Ser. No. 11/459,615, “Touch Screen Keyboards For Portable Electronic Devices,” filed Jul. 24, 2006, the contents of which are hereby incorporated by reference in their entirety. The keyboard embodiments may include a reduced number of icons (or soft keys) relative to the number of keys in existing physical keyboards, such as that for a typewriter. This may make it easier for users to select one or more icons in the keyboard, and thus, one or more corresponding symbols. The keyboard embodiments may be adaptive. For example, displayed icons may be modified in accordance with user actions, such as selecting one or more icons and/or one or more corresponding symbols. One or more applications on the device may utilize common and/or different keyboard embodiments. Thus, the keyboard embodiment used may be tailored to at least some of the applications. In some embodiments, one or more keyboard embodiments may be tailored to a respective user. For example, one or more keyboard embodiments may be tailored to a respective user based on a word usage history (lexicography, slang, individual usage) of the respective user. Some of the keyboard embodiments may be adjusted to reduce a probability of a user error when selecting one or more icons, and thus one or more symbols, when using the soft keyboard embodiments.

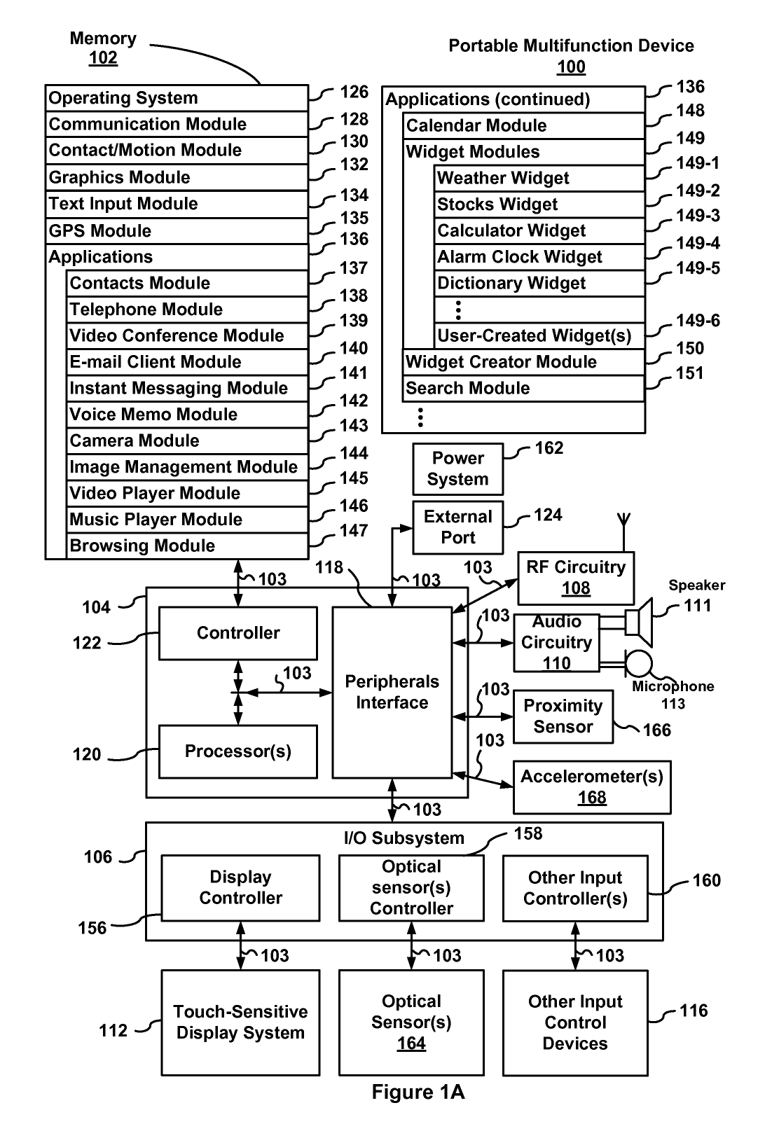

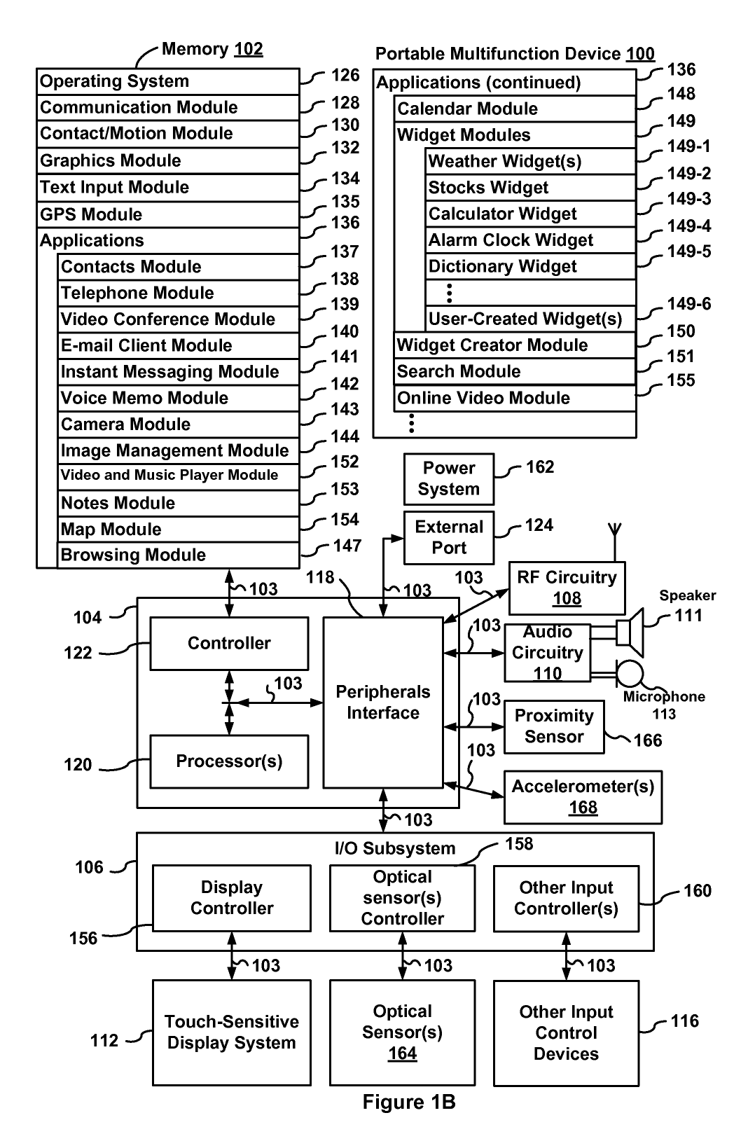

Attention is now directed towards embodiments of portable devices with touch-sensitive displays. FIGS. 1A and 1B are block diagrams illustrating portable multifunction devices 100 with touch-sensitive displays 112 in accordance with some embodiments. The touch-sensitive display 112 is sometimes called a “touch screen” for convenience, and may also be known as or called a touch-sensitive display system. The device 100 may include memory 102, a memory controller 122, one or more processing units (CPU's) 120, a peripherals interface 118, RF circuitry 108, audio circuitry 110, a speaker 111, a microphone 113, an input/output (I/O) subsystem 106, other input or control devices 116, and an external port 124. The device 100 may include one or more optical sensors 164. These components may communicate over one or more communication buses or signal lines 103.

It should be appreciated that the device 100 is only one example of a portable multifunction device 100, and that the device 100 may have more or fewer components than shown, may combine two or more components, or a may have a different configuration or arrangement of the components. The various components shown in FIGS. 1A and 1B may be implemented in hardware, software, or a combination of both hardware and software, including one or more signal processing and/or application specific integrated circuits.

Memory 102 may include high-speed random access memory and may also include non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122. Memory 102, or the non-volatile memory of memory 102, includes one or more computer readable storage mediums.

The peripherals interface 118 couples the input and output peripherals of the device to the CPU 120 and memory 102. The one or more processors 120 run or execute various software programs and/or sets of instructions stored in memory 102 to perform various functions for the device 100 and to process data.

In some embodiments, the peripherals interface 118, the CPU 120, and the memory controller 122 may be implemented on a single chip, such as a chip 104. In some other embodiments, they may be implemented on separate chips.

The RF (radio frequency) circuitry 108 receives and sends RF signals, also called electromagnetic signals. The RF circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS)), or any other suitable communication protocol, including communication protocols not yet developed as of the filing date of this document.

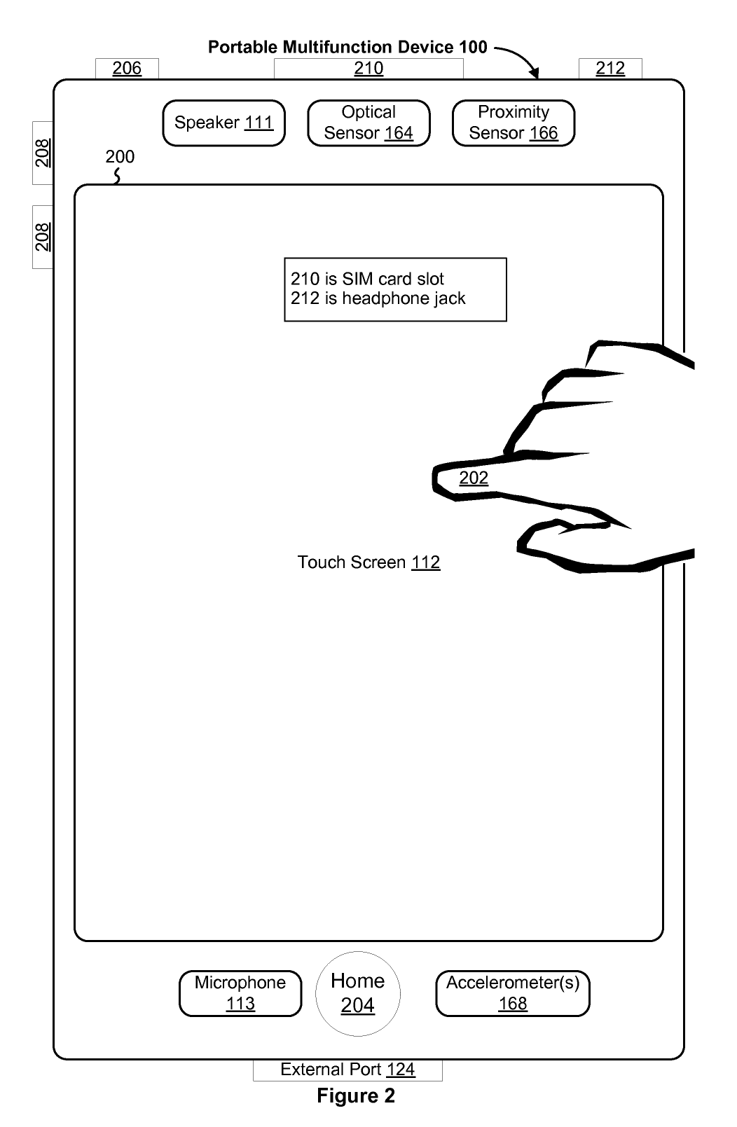

The audio circuitry 110, the speaker 111, and the microphone 113 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. In some embodiments, the audio circuitry 110 also includes a headset jack (e.g. 212, FIG. 2). The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons (e.g., 208, FIG. 2) may include an up/down button for volume control of the speaker 111 and/or the microphone 113. The one or more buttons may include a push button (e.g., 206, FIG. 2). A quick press of the push button may disengage a lock of the touch screen 112 or begin a process that uses gestures on the touch screen to unlock the device, as described in U.S. patent application Ser. No. 11/322,549, “Unlocking a Device by Performing Gestures on an Unlock Image,” filed Dec. 23, 2005, which is hereby incorporated by reference in its entirety. A longer press of the push button (e.g., 206) may turn power to the device 100 on or off. The user may be able to customize a functionality of one or more of the buttons. The touch screen 112 is used to implement virtual or soft buttons and one or more soft keyboards.

The touch-sensitive touch screen 112 provides an input interface and an output interface between the device and a user. The display controller 156 receives and/or sends electrical signals from/to the touch screen 112. The touch screen 112 displays visual output to the user. The visual output may include graphics, text, icons, video, and any combination thereof (collectively termed “graphics”). In some embodiments, some or all of the visual output may correspond to user-interface objects.

A touch screen 112 has a touch-sensitive surface, sensor or set of sensors that accepts input from the user based on haptic and/or tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects (e.g., one or more soft keys, icons, web pages or images) that are displayed on the touch screen. In an exemplary embodiment, a point of contact between a touch screen 112 and the user corresponds to a finger of the user.

The touch screen 112 may use LCD (liquid crystal display) technology, or LPD (light emitting polymer display) technology, although other display technologies may be used in other embodiments. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112. In an exemplary embodiment, projected mutual capacitance sensing technology is used, such as that found in the iPhone® and iPod Touch® from Apple Inc. of Cupertino, Calif.

A touch-sensitive display in some embodiments of the touch screen 112 may be analogous to the multi-touch sensitive tablets described in the following U.S. Pat. No.: 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, a touch screen 112 displays visual output from the portable device 100, whereas touch-sensitive tablets do not provide visual output.

A touch-sensitive display in some embodiments of the touch screen 112 may be as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

The touch screen 112 may have a resolution in excess of 100 dpi. In an exemplary embodiment, the touch screen has a resolution of approximately 160 dpi. The user may make contact with the touch screen 112 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, the device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 112 or an extension of the touch-sensitive surface formed by the touch screen.

In some embodiments, the device 100 may include a physical or virtual click wheel as an input control device 1 16. A user may navigate among and interact with one or more graphical objects (e.g., icons) displayed in the touch screen 112 by rotating the click wheel or by moving a point of contact with the click wheel (e.g., where the amount of movement of the point of contact is measured by its angular displacement with respect to a center point of the click wheel). The click wheel may also be used to select one or more of the displayed icons. For example, the user may press down on at least a portion of the click wheel or an associated button. User commands and navigation commands provided by the user via the click wheel may be processed by an input controller 160 as well as one or more of the modules and/or sets of instructions in memory 102. For a virtual click wheel, the click wheel and click wheel controller may be part of the touch screen 112 and the display controller 156, respectively. For a virtual click wheel, the click wheel may be either an opaque or semitransparent object that appears and disappears on the touch screen display in response to user interaction with the device. In some embodiments, a virtual click wheel is displayed on the touch screen of a portable multifunction device and operated by user contact with the touch screen.

The device 100 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The device 100 may also include one or more optical sensors 164. FIGS. 1A and 1B show an optical sensor coupled to an optical sensor controller 158 in I/O subsystem 106. The optical sensor 164 may include charge-coupled device (CCD) or complementary metal-oxide semiconductor (CMOS) phototransistors. The optical sensor 164 receives light from the environment, projected through one or more lens, and converts the light to data representing an image. In conjunction with an imaging module 143 (also called a camera module), the optical sensor 164 may capture still images or video. In some embodiments, an optical sensor is located on the back of the device 100, opposite the touch screen display 112 on the front of the device, so that the touch screen display may be used as a viewfinder for still and/or video image acquisition. In some embodiments, an optical sensor is located on the front of the device so that the user's image may be obtained for videoconferencing while the user views the other video conference participants on the touch screen display. In some embodiments, the position of the optical sensor 164 can be changed by the user (e.g., by rotating the lens and the sensor in the device housing) so that a single optical sensor 164 may be used along with the touch screen display for both video conferencing and still and/or video image acquisition.

The device 100 may also include one or more proximity sensors 166. FIGS. 1A and 1B show a proximity sensor 166 coupled to the peripherals interface 118. Alternately, the proximity sensor 166 may be coupled to an input controller 160 in the I/O subsystem 106. The proximity sensor 166 may perform as described in U.S. patent application Ser. No. 11/241,839, “Proximity Detector In Handheld Device”; U.S. Ser. No. 11/240,788, “Proximity Detector In Handheld Device”; U.S. Ser. No. 11/620,702, “Using Ambient Light Sensor To Augment Proximity Sensor Output”; U.S. Ser. No. 11/586,862, “Automated Response To And Sensing Of User Activity In Portable Devices”; and U.S. Ser. No. 11/638,251, “Methods And Systems For Automatic Configuration Of Peripherals,” which are hereby incorporated by reference in their entirety. In some embodiments, the proximity sensor turns off and disables the touch screen 112 when the multifunction device is placed near the user's ear (e.g., when the user is making a phone call). In some embodiments, the proximity sensor keeps the screen off when the device is in the user's pocket, purse, or other dark area to prevent unnecessary battery drainage when the device is a locked state.

The device 100 may also include one or more accelerometers 168. FIGS. 1A and 1B show an accelerometer 168 coupled to the peripherals interface 118. Alternately, the accelerometer 168 may be coupled to an input controller 160 in the I/O subsystem 106. The accelerometer 168 may perform as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are which are incorporated by reference herein in their entirety. In some embodiments, information is displayed on the touch screen display in a portrait view or a landscape view based on an analysis of data received from the one or more accelerometers.

In some embodiments, the software components stored in memory 102 (e.g., in a computer readable storage medium of memory 102) may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, and applications (or set of instructions) 136.

The operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 128 facilitates communication with other devices over one or more external ports 124 and also includes various software components for handling data received by the RF circuitry 108 and/or the external port 124. The external port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

The contact/motion module 130 may detect contact with the touch screen 112 (in conjunction with the display controller 156) and other touch-sensitive devices (e.g., a touchpad or physical click wheel). The contact/motion module 130 includes various software components for performing various operations related to detection of contact, such as determining if contact has occurred (e.g., detecting a finger-down event), determining if there is movement of the contact and tracking the movement across the touch-sensitive surface (e.g., detecting one or more finger-dragging events), and determining if the contact has ceased (e.g., detecting a finger-up event or a break in contact). The contact/motion module 130 receives contact data from the touch-sensitive surface. Determining movement of the point of contact, which is represented by a series of contact data, may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, the contact/motion module 130 and the display controller 156 detects contact on a touchpad. In some embodiments, the contact/motion module 130 and the controller 160 detects contact on a click wheel.

The contact/motion module 130 may detect a gesture input by a user. Different gestures on the touch-sensitive surface have different contact patterns. Thus, a gesture may be detected by detecting a particular contact pattern. For example, detecting a finger tap gesture comprises detecting a finger-down event followed by detecting a finger-up event at the same position (or substantially the same position) as the finger-down event (e.g., at the position of an icon). As another example, detecting a finger swipe gesture on the touch-sensitive surface comprises detecting a finger-down event followed by detecting one or more finger-dragging events, and subsequently followed by detecting a finger-up event.

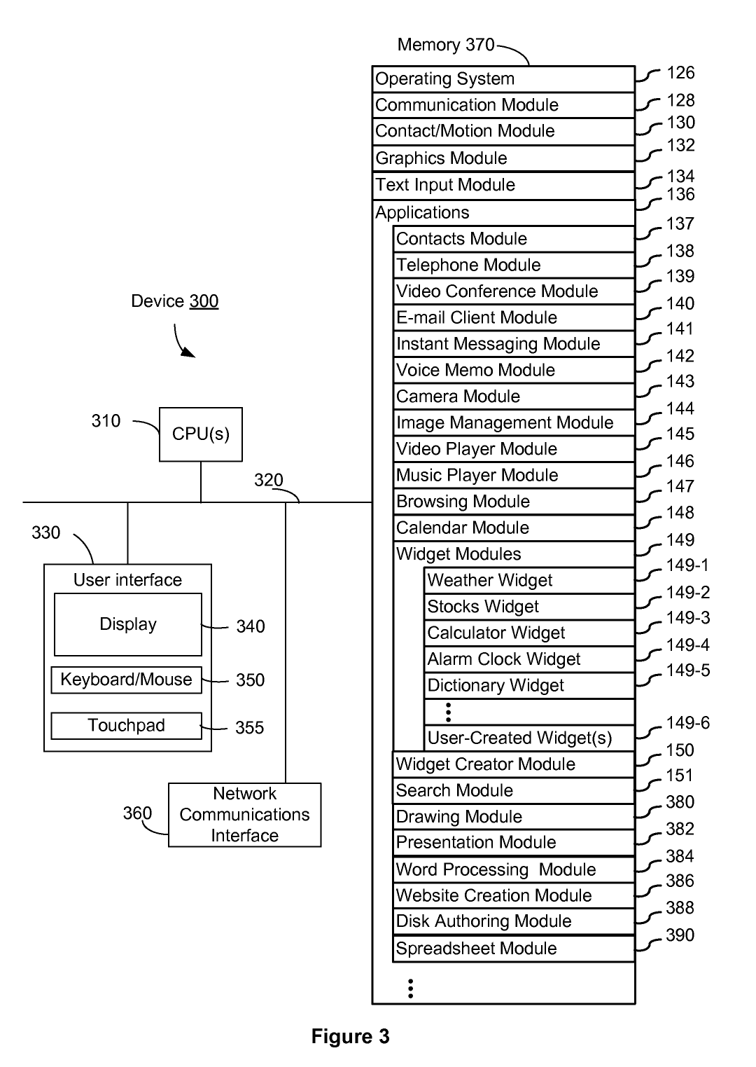

In some embodiments, the contact/motion module 130 (FIG. 3) detects finger swipe gestures, and implements scrolling of information on the display (112, FIG. 2; 340, FIG. 3) of the device when one or more finger swipe gestures made with a user's finger meet predefined criteria.

The graphics module 132 includes various known software components for rendering and displaying graphics on the touch screen 112 or other display, including components for changing the intensity of graphics that are displayed. As used herein, the term “graphics” includes any object that can be displayed to a user, including without limitation text, web pages, icons (such as user-interface objects including soft keys), digital images, videos, animations and the like.

In some embodiments, the graphics module 132 stores data representing graphics to be used. Each graphic may be assigned a corresponding code. The graphics module 132 receives, from applications etc., one or more codes specifying graphics to be displayed along with, if necessary, coordinate data and other graphic property data, and then generates screen image data to output to display controller 156.

The text input module 134, which may be a component of graphics module 132, provides soft keyboards for entering text in various applications (e.g., contacts 137, e-mail 140, IM 141, browser 147, and any other application that needs text input).

The GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

The applications 136 may include the following modules (or sets of instructions), or a subset or superset thereof:
a contacts module 137 (sometimes called an address book or contact list);
a telephone module 138;
a video conferencing module 139;
an e-mail client module 140;
an instant messaging (IM) module 141;
a voice memo module 142;
a camera module 143 for still and/or video images;
an image management module 144;
a video player module 145;
a music player module 146;
a browser module 147;
a calendar module 148;
widget modules 149, which may include weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module 145 and music player module 146;
notes module 153;
map module 154; and/or
online video module 155.

Examples of other applications 136 that may be stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact module 130, graphics module 132, and text input module 134, the contacts module 137 may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, the telephone module 138 may be used to enter a sequence of characters corresponding to a telephone number, access one or more telephone numbers in the address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, the videoconferencing module 139 may be used to initiate, conduct, and terminate a video conference between a user and one or more other participants.

In conjunction with RF circuitry 108, touch screen 112, display controller 156, contact module 130, graphics module 132, and text input module 134, the e-mail client module 140 may be used to create, send, receive, and manage e-mail. In conjunction with image management module 144, the e-mail module 140 makes it very easy to create and send e-mails with still or video images taken with camera module 143.

In conjunction with RF circuitry 108, touch screen 112, display controller 156, contact module 130, graphics module 132, and text input module 134, the instant messaging module 141 may be used to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages may include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact module 130, graphics module 132, text input module 134, e-mail client module 140 and instant messaging module 141, the voice memo module 142 may be used to record audio of lectures, dictation, telephone calls, conversations, performances, etc., and send the audio in an email or instant message.

In conjunction with touch screen 112, display controller 156, optical sensor(s) 164, optical sensor controller 158, contact module 130, graphics module 132, and image management module 144, the camera module 143 may be used to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, the image management module 144 may be used to arrange, modify (e.g., edit), or otherwise manipulate, label, delete, present (e.g., in a digital slide show or album), and store still and/or video images.

In conjunction with touch screen 112, display controller 156, contact module 130, graphics module 132, audio circuitry 110, and speaker 111, the video player module 145 may be used to display, present or otherwise play back videos (e.g., on the touch screen or on an external, connected display via external port 124).

In conjunction with touch screen 112, display system controller 156, contact module 130, graphics module 132, audio circuitry 110, speaker 111, RF circuitry 108, and browser module 147, the music player module 146 allows the user to download and play back recorded music and other sound files stored in one or more file formats, such as MP3 or AAC files. In some embodiments, the device 100 may include the functionality of an MP3 player, such as an iPod (trademark of Apple Inc.).

In conjunction with RF circuitry 108, touch screen 112, display system controller 156, contact module 130, graphics module 132, and text input module 134, the browser module 147 may be used to browse the Internet, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail module 140, and browser module 147, the calendar module 148 may be used to create, display, modify, and store calendars and data associated with calendars (e.g., calendar entries, to do lists, etc.).

In conjunction with RF circuitry 108, touch screen 112, display system controller 156, contact module 130, graphics module 132, text input module 134, and browser module 147, the widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 may be used by a user to create widgets (e.g., turning a user-specified portion of a web page into a widget).

In conjunction with touch screen 112, display system controller 156, contact module 130, graphics module 132, and text input module 134, the search module 151 may be used to search for text, music, sound, image, video, and/or other files in memory 102 that match one or more search criteria (e.g., one or more user-specified search terms).

In conjunction with touch screen 112, display controller 156, contact module 130, graphics module 132, and text input module 134, the notes module 153 may be used to create and manage notes, to do lists, and the like.

In conjunction with RF circuitry 108, touch screen 112, display system controller 156, contact module 130, graphics module 132, text input module 134, GPS module 135, and browser module 147, the map module 154 may be used to receive, display, modify, and store maps and data associated with maps (e.g., driving directions; data on stores and other points of interest at or near a particular location; and other location-based data).

In conjunction with touch screen 112, display system controller 156, contact module 130, graphics module 132, audio circuitry 110, speaker 111, RF circuitry 108, text input module 134, e-mail client module 140, and browser module 147, the online video module 155 allows the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the content of which is hereby incorporated by reference in its entirety.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various embodiments. For example, video player module 145 may be combined with music player module 146 into a single module (e.g., video and music player module 152, FIG. 1B). In some embodiments, memory 102 may store a subset of the modules and data structures identified above. Furthermore, memory 102 may store additional modules and data structures not described above.

In some embodiments, the device 100 is a device where operation of a predefined set of functions on the device is performed exclusively through a touch screen 112 and/or a touchpad. By using a touch screen and/or a touchpad as the primary input/control device for operation of the device 100, the number of physical input/control devices (such as push buttons, dials, and the like) on the device 100 may be reduced.

The predefined set of functions that may be performed exclusively through a touch screen and/or a touchpad include navigation between user interfaces. In some embodiments, the touchpad, when touched by the user, navigates the device 100 to a main, home, or root menu from any user interface that may be displayed on the device 100. In such embodiments, the touchpad may be referred to as a “menu button.” In some other embodiments, the menu button may be a physical push button or other physical input/control device instead of a touchpad.

FIG. 2 illustrates a portable multifunction device 100 having a touch screen 112 in accordance with some embodiments. The touch screen may display one or more graphics within user interface (UT) 200. In this embodiment, as well as others described below, a user may select one or more of the graphics by making contact or touching the graphics, for example, with one or more fingers 202 (not drawn to scale in the figure). In some embodiments, selection of one or more graphics occurs when the user breaks contact with the one or more graphics. In some embodiments, the contact may include a gesture, such as one or more taps, one or more swipes (from left to right, right to left, upward and/or downward) and/or a rolling of a finger (from right to left, left to right, upward and/or downward) that has made contact with the device 100. In some embodiments, inadvertent contact with a graphic may not select the graphic. For example, a swipe gesture that sweeps over an application icon may not select the corresponding application when the gesture corresponding to selection is a tap.

The device 100 may also include one or more physical buttons, such as “home” or menu button 204. As described previously, the menu button 204 may be used to navigate to any application 136 in a set of applications that may be executed on the device 100. Alternatively, in some embodiments, the menu button is implemented as a soft key in a GUI in touch screen 112.

In one embodiment, the device 100 includes a touch screen 112, a menu button 204, a push button 206 for powering the device on/off and locking the device, volume adjustment button(s) 208, a Subscriber Identity Module (SIM) card slot 210, a head set jack 212, and a docking/charging external port 124. The push button 206 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, the device 100 also may accept verbal input for activation or deactivation of some functions through the microphone 113.

FIG. 3 is a block diagram of an exemplary computing device with a display and a touch-sensitive surface in accordance with some embodiments. Device 300 need not be portable. In some embodiments, the device 300 is a laptop computer, a desktop computer, a table computer, a multimedia player device, a navigation device, an educational device (such as a child's learning toy), a gaming system, or a control device (e.g., a home or industrial controller). The device 300 typically includes one or more processing units (CPU's) 310, one or more network or other communications interfaces 360, memory 370, and one or more communication buses 320 for interconnecting these components. The communication buses 320 may include circuitry (sometimes called a chipset) that interconnects and controls communications between system components. The device 300 includes a user interface 330 comprising a display 340, which in some embodiments is a touch screen display. The user interface 330 also may include a keyboard and/or mouse (or other pointing device) 350 and a touchpad 355. Memory 370 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 370 may optionally include one or more storage devices remotely located from the CPU(s) 310. In some embodiments, memory 370 stores programs, modules, and data structures analogous to the programs, modules, and data structures stored in the memory 102 of portable multifunction device 100 (FIG. 1), or a subset thereof. Furthermore, memory 370 may store additional programs, modules, and data structures not present in the memory 102 of portable multifunction device 100. For example, memory 370 of device 300 may store drawing module 380, presentation module 382, word processing module 384, website creation module 386, disk authoring module 388, and/or spreadsheet module 390, while memory 102 of portable multifunction device 100 (FIG. 1) may not store these modules.

Each of the above identified elements in FIG. 3 may be stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 370 may store a subset of the modules and data structures identified above. Furthermore, memory 370 may store additional modules and data structures not described above.

Attention is now directed towards embodiments of user interfaces (“UT”) that may be implemented on a portable multifunction device 100.

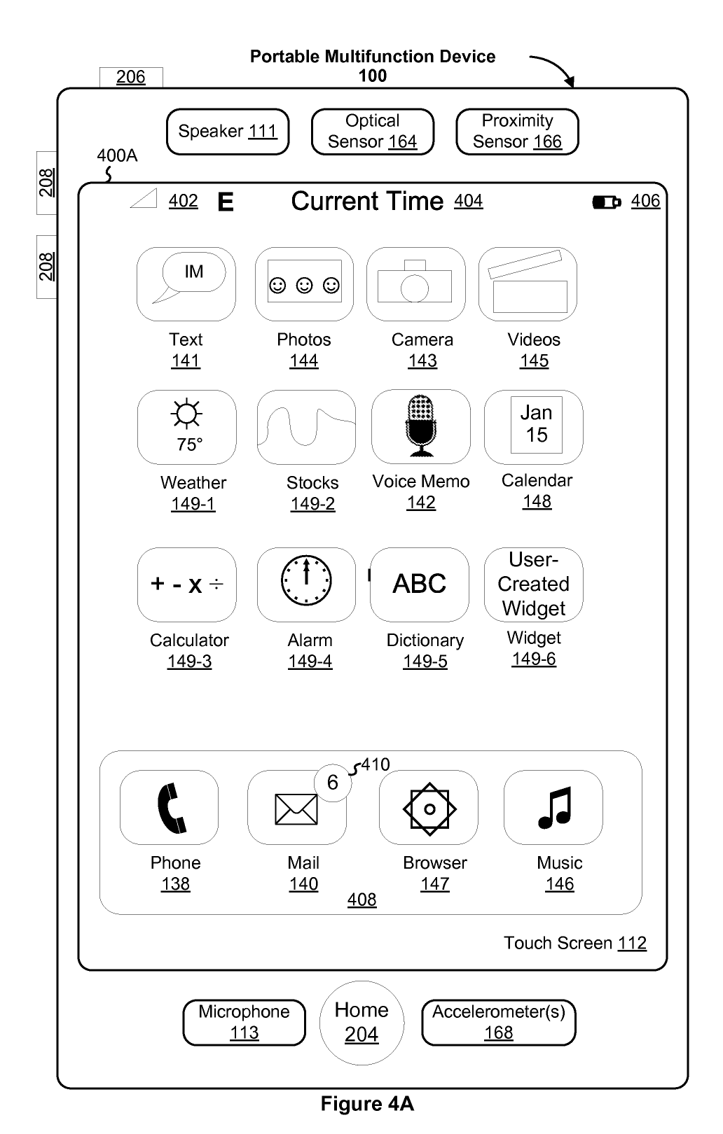

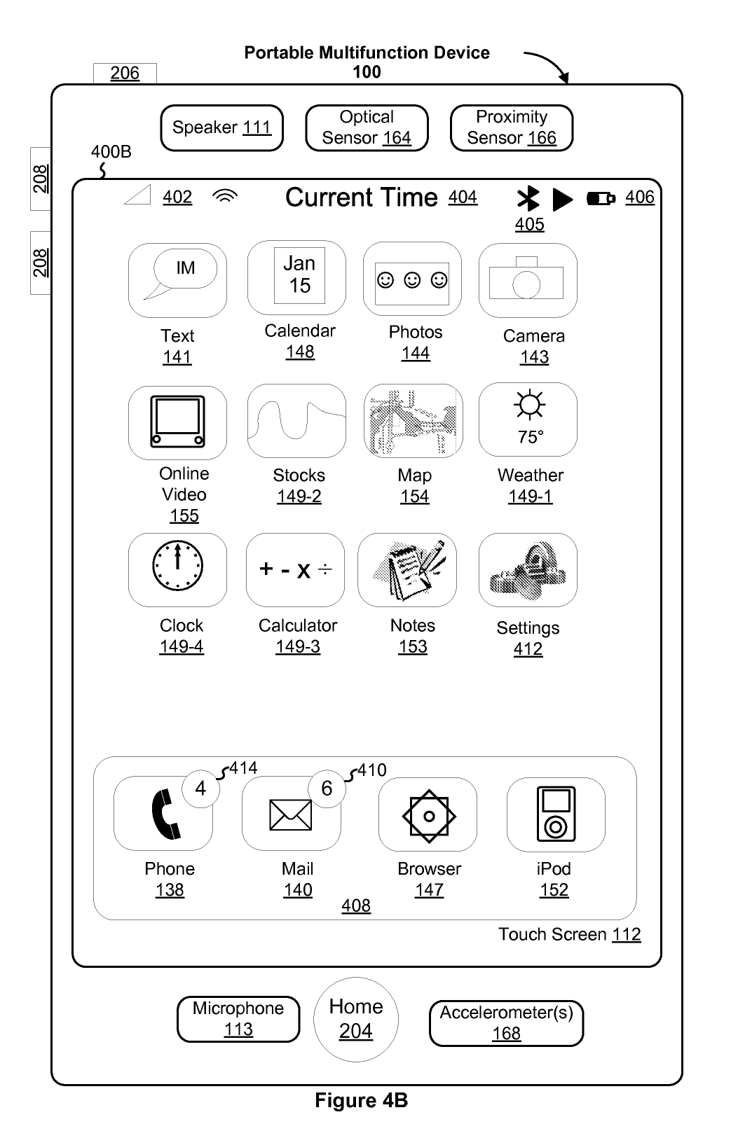

FIGS. 4A and 4B illustrate exemplary user interfaces for a menu of applications on a portable multifunction device 100 in accordance with some embodiments. Similar user interfaces may be implemented on device 300. In some embodiments, user interface 400A includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Phone 138, which may include an indicator 414 of the number of missed calls or voicemail messages;
   E-mail client 140, which may include an indicator 410 of the number of unread e-mails;
   Browser 147; and
   Music player 146; and
Icons for other applications, such as:
   IM 141;
   Image management 144;
   Camera 143;
   Video player 145;
   Weather 149-1;
   Stocks 149-2;
   Voice memo 142;
   Calendar 148;
   Calculator 149-3;
   Alarm clock 149-4;
   Dictionary 149-5; and
   User-created widget 149-6.

In some embodiments, user interface 400B includes the following elements, or a subset or superset thereof:
402, 404, 405, 406, 141, 148, 144, 143, 149-3, 149-2, 149-1, 149-4, 410, 414, 138, 140, and 147, as described above;
Map 154;
Notes 153;
Settings 412, which provides access to settings for the device 100 and its various applications 136, as described further below;
Video and music player module 152, also referred to as iPod (trademark of Apple Inc.) module 152; and
Online video module 155, also referred to as YouTube (trademark of Google Inc.) module 155.

Attention is now directed towards embodiments of user interfaces (“UT”) and associated processes that may be implemented on an electronic device with a display and a touch-sensitive surface, such as device 300 or portable multifunction device 100.

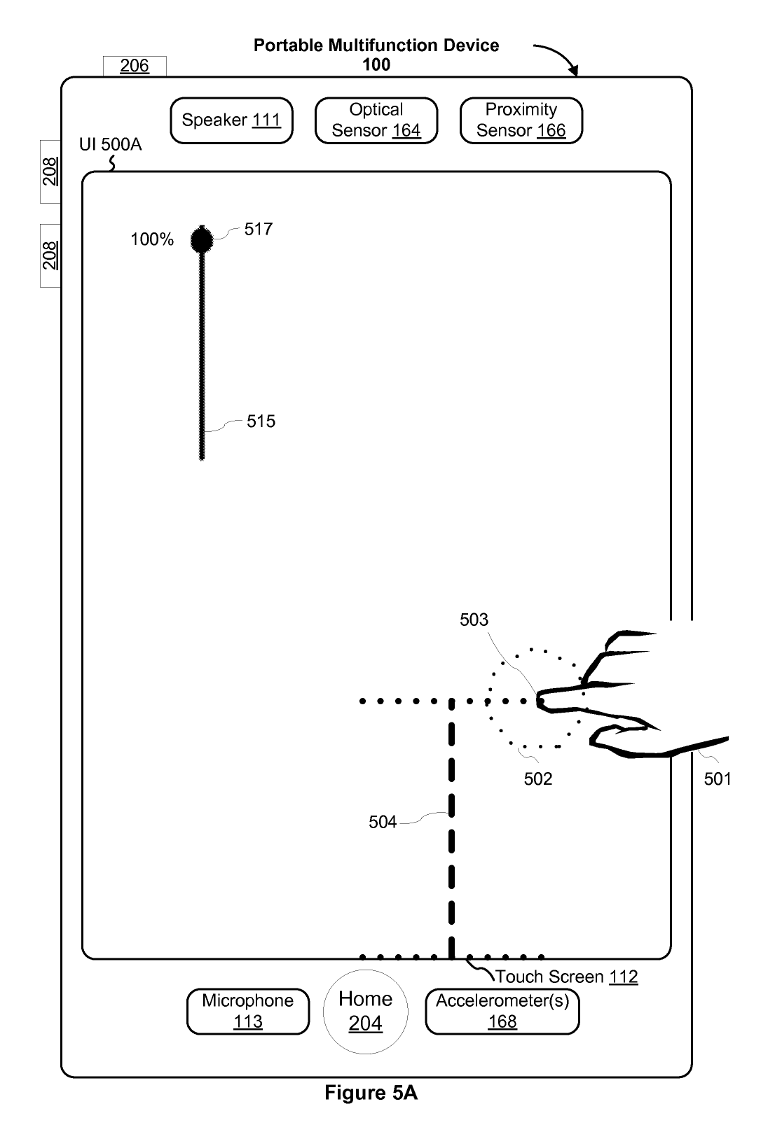

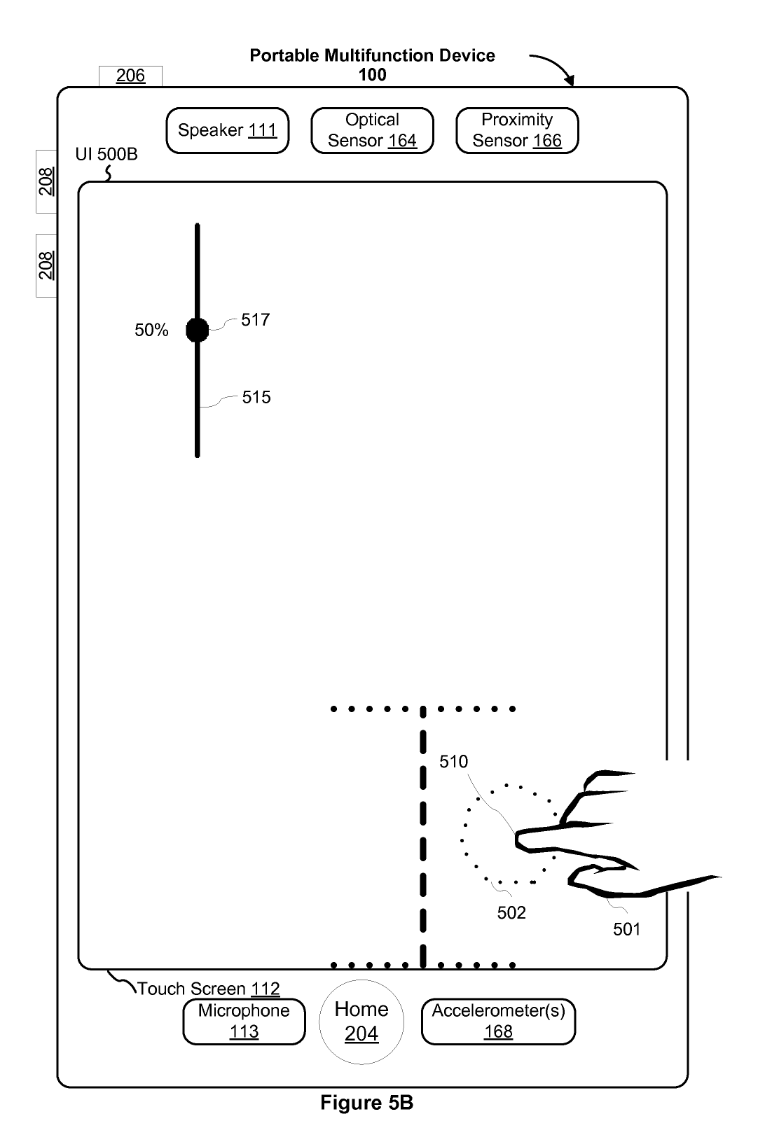

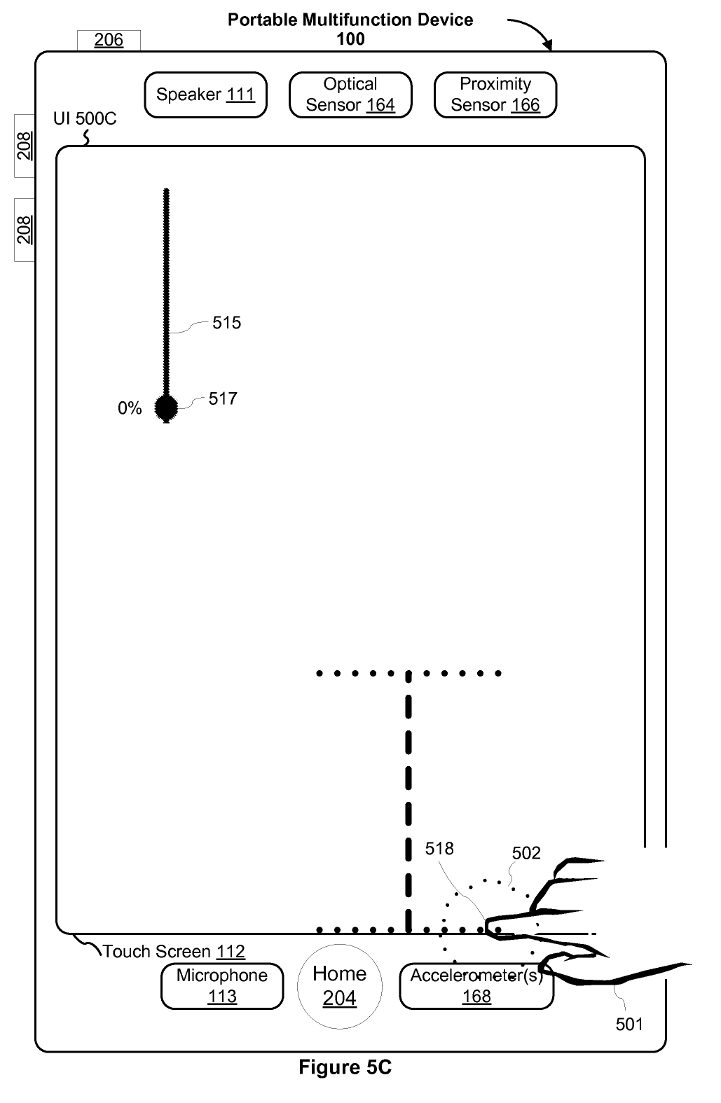

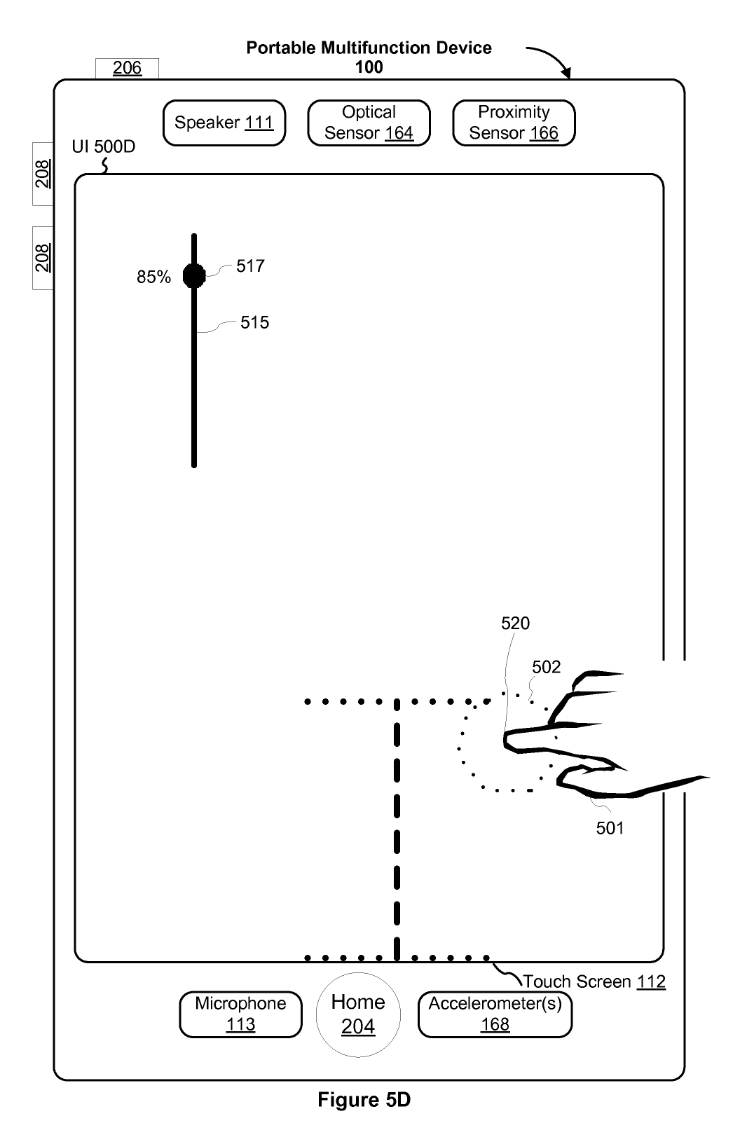

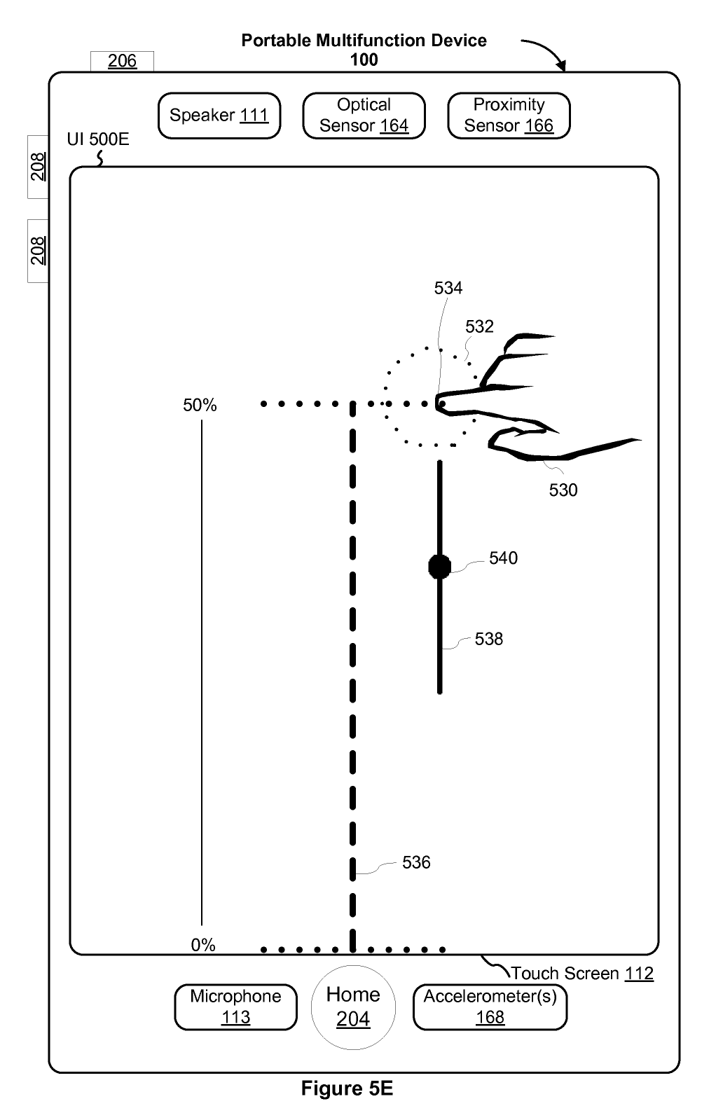

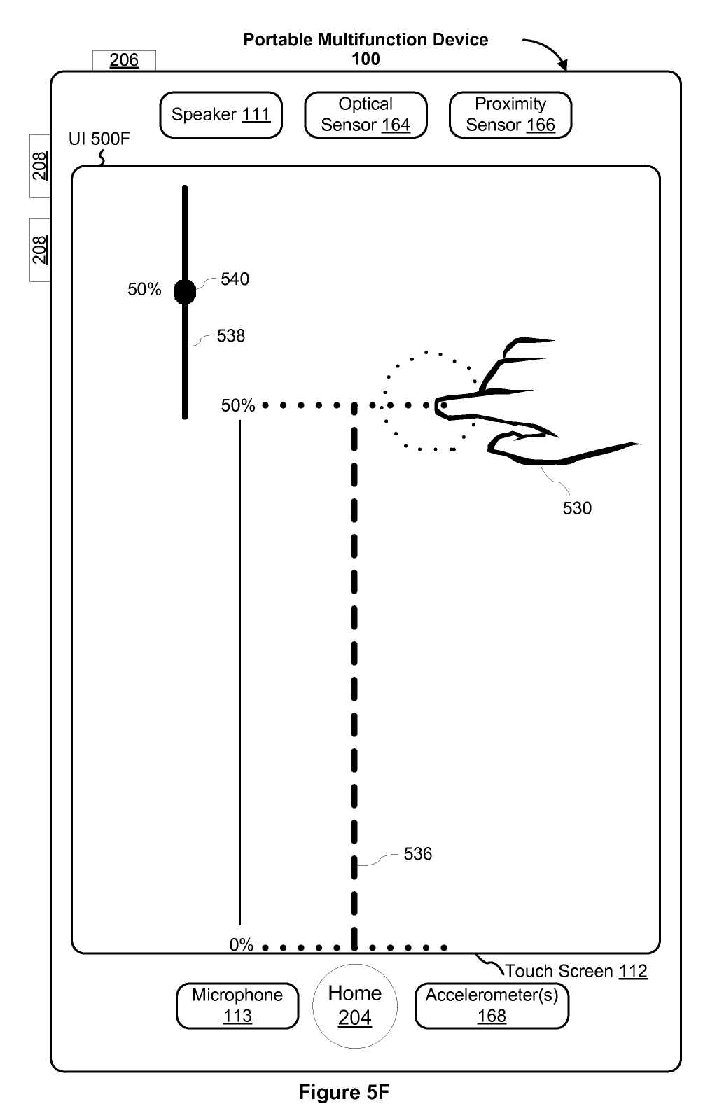

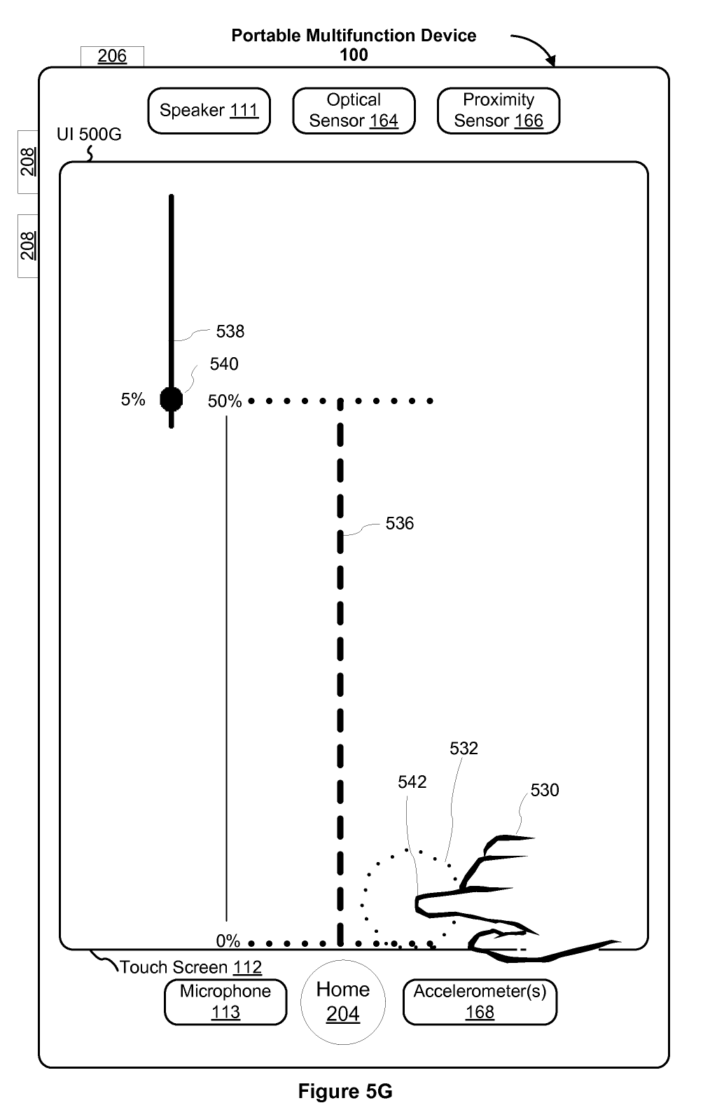

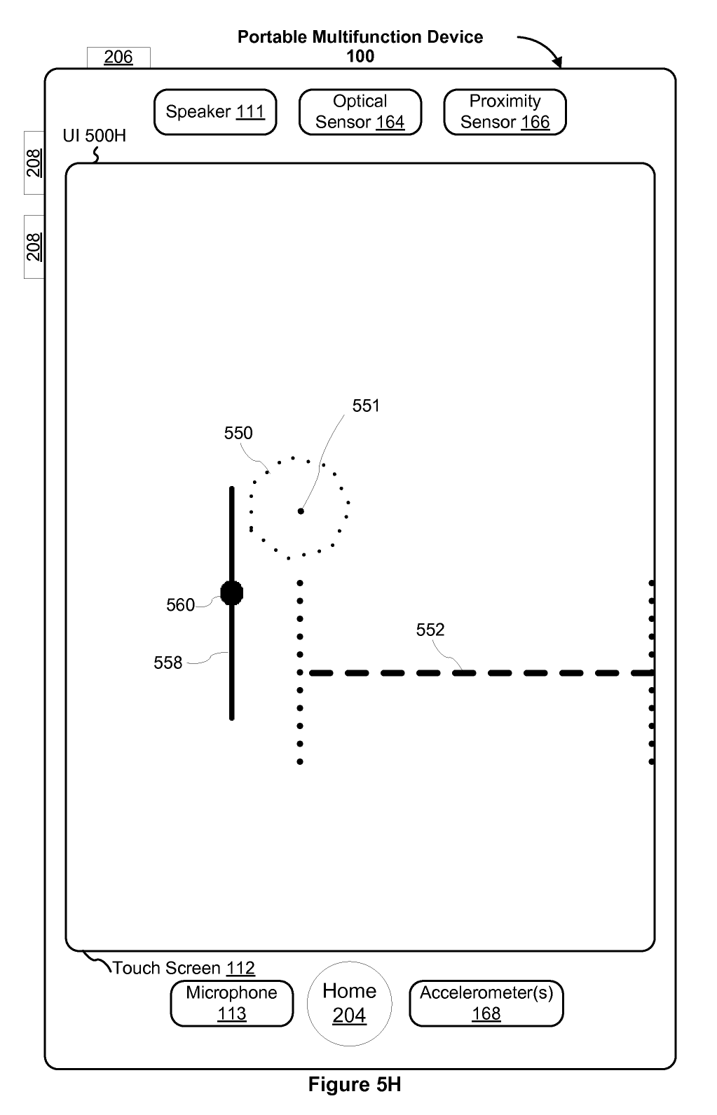

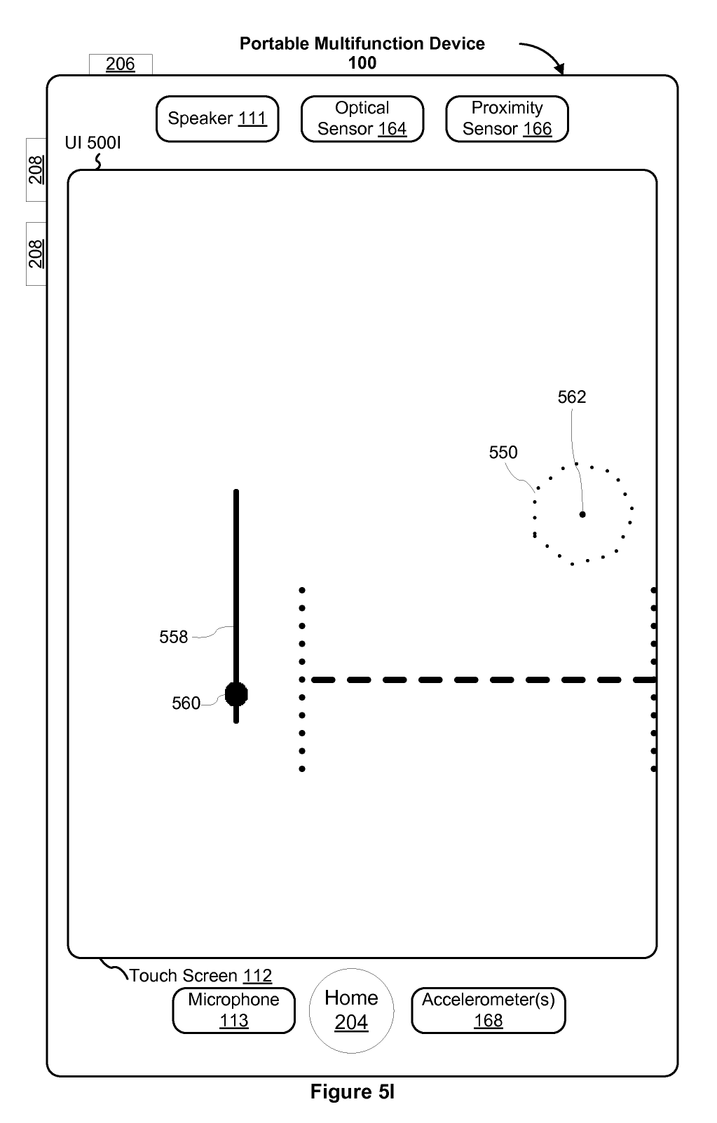

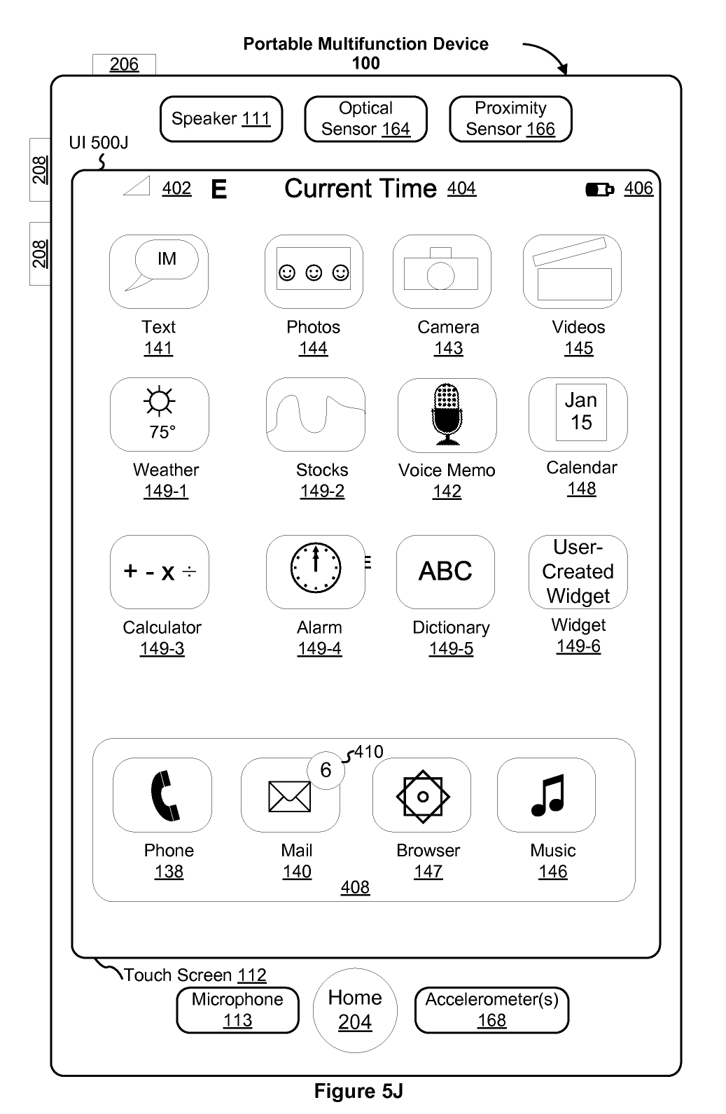

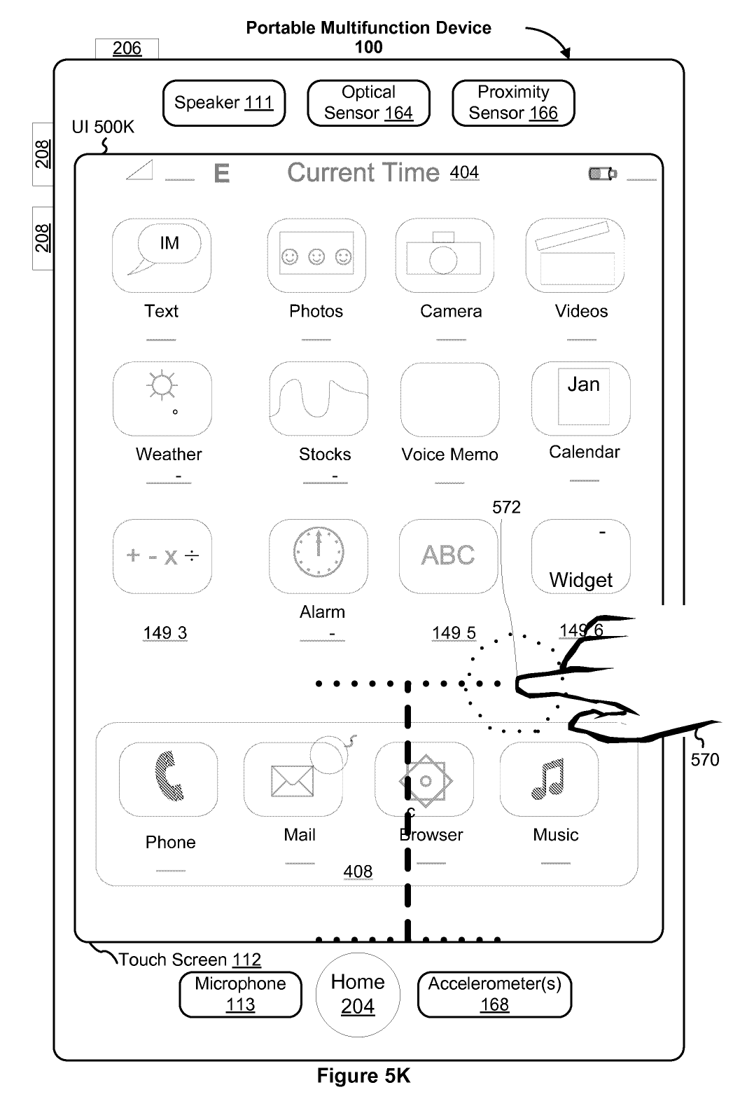

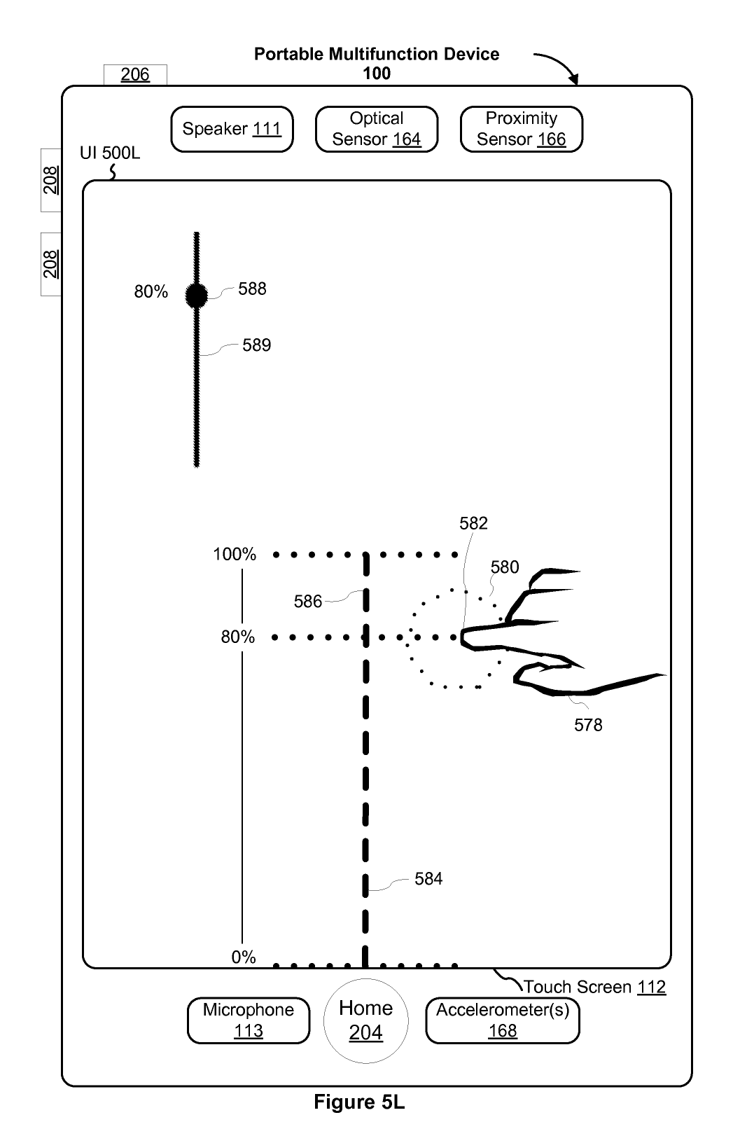

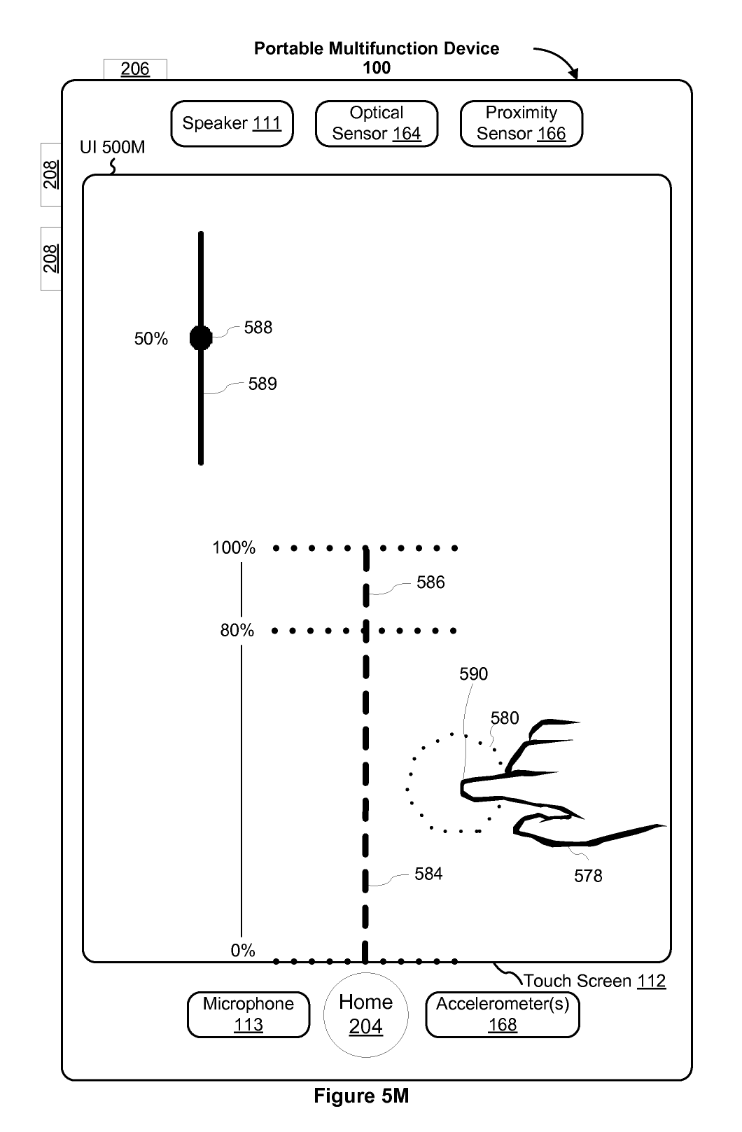

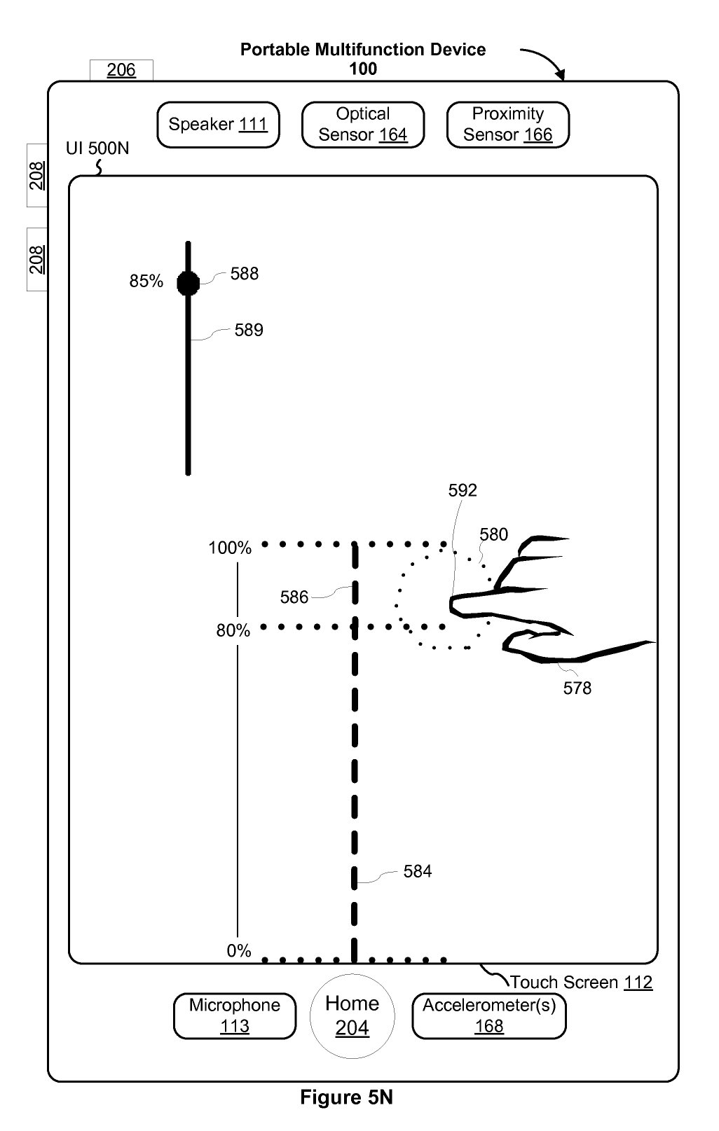

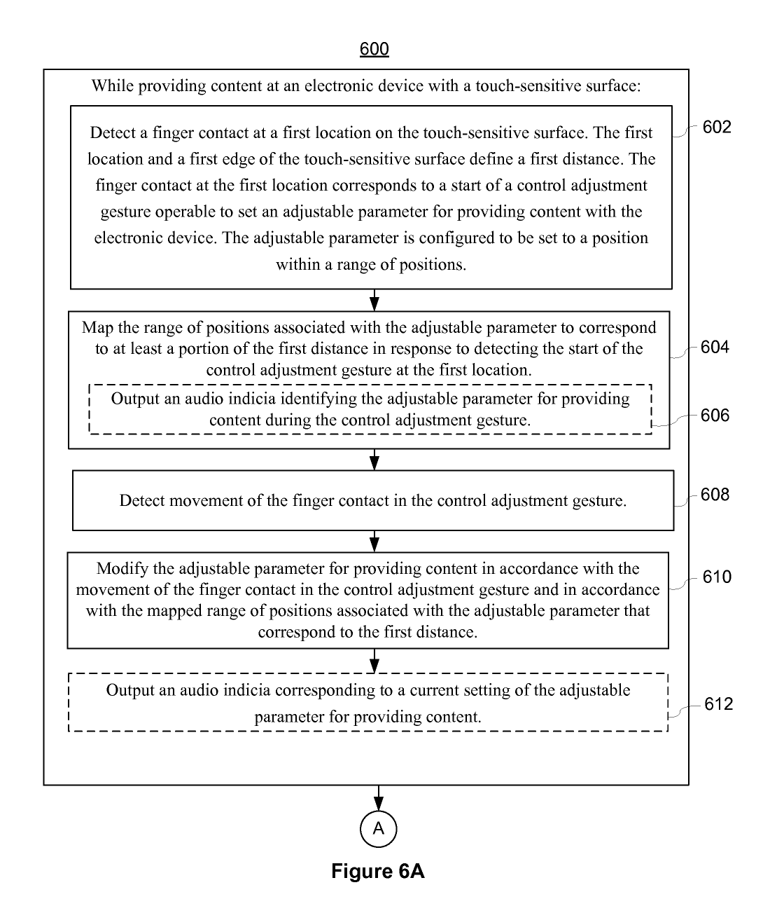

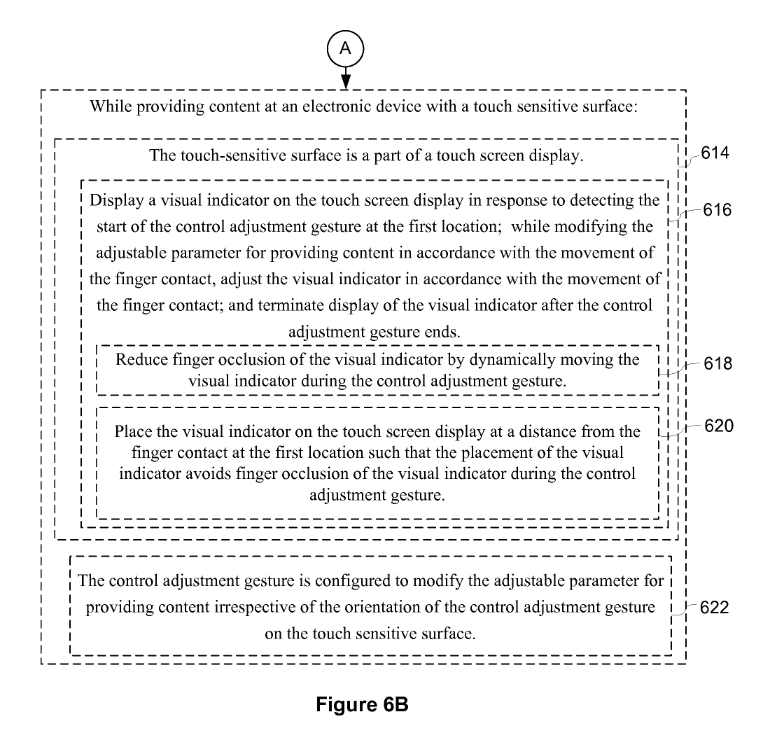

FIGS. 5A-5N illustrate exemplary user interfaces for adjusting a playback control with a finger gesture in accordance with some embodiments. FIGS. 5A-5N will be described more fully below with respect to FIGS. 6A-6B.

For purposes of clarity, very few graphics are displayed on the touch screen 112 in UI 500A-UI 500S and UI 500L-UI 500N (e.g., just a visual indicator 515 and a setting indicia 517 are displayed in UI 500A, FIG. 5A). But it will be understood that additional graphics may be displayed without impacting operation of the methods, electronic devices, or computer readable storage mediums, etc., disclosed herein.

UI 500A-UI 500D (FIGS. 5A-5D) illustrate a control adjustment gesture in accordance with some embodiments.

In UI 500A (FIG. 5A), a user's finger gesture 501 (not drawn to scale in the figure) makes a finger contact 502 at a first location 503 on touch screen 112. The first location 503 and an edge of touch screen 112 define a first distance 504. The user's finger gesture 501 corresponds to the start of a control adjustment gesture operable to set an adjustable parameter for providing content with the portable multifunction device 100 (e.g., adjusting the volume of the content being played on the device). The adjustable parameter may be configurable to be set to a position within a range of positions, such as 10% volume, 95% volume, etc.

In some embodiments, visual indicator 515 is displayed in response to detecting the start of the control adjustment gesture. Visual indicator 515 may include setting indicia 517 to provide a visual indication to the user of the current value of the adjustable parameter. Here, the setting indicia 517 reflects that the adjustable parameter was set to 100% at the start of user finger gesture 501. The brace and numeric 100% value adjacent to visual indicator 515 are for illustrative purposes in the figure, though in some embodiments, visual indicator 515 may also include numeric indicators to reflect the current setting of the adjustable parameter.

UI 500B (FIG. 5B) illustrates that the finger contact 502 of user's finger gesture 501 has moved to a second location 510 on touch screen 112. Accordingly, the setting indicia 517 of visual indicator 515 has moved to a second position on visual indicator 515 in accordance with the movement of the finger contact 502, which in this example, reflects that the adjustable parameter is now set at 50%.

UI 500C (FIG. 5C) illustrates that the finger contact 502 of user's finger gesture 501 has moved to a third location 518 on touch screen 112, i.e., the edge of touch screen 112. Accordingly, the setting indicia 517 of visual indicator 515 has moved to a third position on visual indicator 515 in accordance with the movement of the finger contact 502, which in this example, reflects that the adjustable parameter is now set at 0%.

UI 500D (FIG. 5D) illustrates that the finger contact 502 of user's finger gesture 501 has moved to a third location 520 on touch screen 112. Accordingly, the setting indicia 517 of visual indicator 515 has moved to a fourth position on visual indicator 515 in accordance with the movement of the finger contact 502, which in this example, reflects that the adjustable parameter is now set at 85%.

After the user's finger gesture 501 as depicted in FIGS. 5A-5D is terminated, the control adjustment gesture is over. Visual indicator 515 is not displayed after the control adjustment gesture is over (see, e.g., UI 500J, FIG. 5J where no control adjustment gesture is displayed). In some embodiments, the visual indicator 515 is displayed for a short period following the end of the control adjustment gesture. In some embodiments, termination of the display of the visual indicator 515 is accomplished by animating the visual indicator 515 fading out to invisibility.

UI 500E-UI 500G (FIGS. 5E-5G) illustrate a second control adjustment gesture in accordance with some embodiments. In FIG. 5E, a user's finger gesture 530 (not drawn to scale in the figure) makes a contact 532 at a first location 534 on touch screen 112, thereby defining a first distance 536 between an edge of the touch screen 112 and the first location 534. In this example, the visual indicator 538 with setting indicia 540 is displayed on touch screen 112 in response to detecting the start of the second control adjustment gesture.

In some embodiments, the first distance is mapped to a subset of the range of settings for the adjustable parameter, in accordance with the adjustable parameter's initial setting and the type of control adjustment gesture. For example, in UI 500E, the adjustable parameter (e.g., volume) was set to 50% before the finger gesture 530 began to initiate a volume decrease gesture, so the first distance 536 is mapped to the range 50% volume to 0% volume so that the user gesture 530 will adjust the adjustable volume parameter within the lower half of the volume range.

In FIG. 5F, the user interface UT 500F has dynamically moved visual indicator 538 during the second control adjustment gesture to reduce finger occlusion of the visual indicator 538. In some embodiments, the device will initially display the visual indicator on the touch-sensitive display at a distance from the user's control adjustment gesture 530 to avoid occlusion of the visual indicator. Alternatively, the foregoing finger occlusion reduction techniques may be used together because they are not mutually exclusive.

UI 500G (FIG. 5G) illustrates that the finger contact 532 of user's finger gesture 530 has moved to a second location 542 on touch screen 112. Accordingly, visual indicator 538's setting indicia 540 has moved to a second position on visual indicator 538 in accordance with the movement of the finger contact 532, which in this example, reflects that the adjustable parameter is now set at 5%.

UI 500H-UI 500I (FIGS. 5H-5I) illustrate a third control adjustment gesture in accordance with some embodiments (for purposes of clarity, just the finger contact in the finger gesture is shown). In FIG. 5H, a user gesture makes a contact 550 at a first location 551 on touch screen 112, thereby defining a first distance 552 between an edge of the touch screen 112 and the first location 551. In this example, the visual indicator 558 with setting indicia 560 is displayed on touch screen 112 in response to detecting the start of the third control adjustment gesture.

In the example of FIGS. 5H-5I, the control adjustment gesture is configured to modify the adjustable parameter for providing content irrespective of the orientation of the control adjustment gesture on the touch-sensitive surface. Thus, in this example, the control adjustment gesture is performed in a direction perpendicular to the directions illustrated by the first and second control adjustment gestures in FIGS. 5A-5D and 5E-5G.

In FIG. 5I, the user's point of contact 550 has moved to a second location 562 on touch screen 112. Accordingly, visual indicator 558's setting indicia 560 has moved to a new position on visual indicator 558 in accordance with the movement of the third control adjustment gesture.

UI 500J- UI 500K illustrate that, in some embodiments, a plurality of user interface elements are displayed in a first state, and in response to detecting the start of a control adjustment gesture, the plurality of user interface elements are displayed in a second state that is visually distinguished from the first state.

For example, in UI 500J (FIG. 5J), a plurality of application icons are displayed in a first state. In some embodiments, the first state for displaying the plurality of user interface elements may include a first level of transparency. In some embodiments, the first state for displaying the plurality of user interface elements may include a first level of brightness. Alternatively, the first state for displaying the plurality of user interface elements may include displaying the user interface elements in color.

UI 500K depicts that in response to detecting the start of the control adjustment gesture 570 at a first location 572 on touch screen 112, the plurality of application icons are displayed in a second state. In some embodiments, the second state for displaying the plurality of user interface elements may include a second level of transparency. In some embodiments, the second state for displaying the plurality of user interface elements may include a second level of brightness. Alternatively, the second state for displaying the plurality of user interface elements may include displaying the user interface elements in grey scale or black and white.

In UI 500K, the application icons are displayed at a second level of brightness that is less than the first level of brightness as depicted in UI 500J (i.e., the application icons displayed on touch screen 112 are dimmed when the control adjustment gesture 570 begins).

In some embodiments, displaying user interface elements in a second state may include an animated transition from the first state to the second state (e.g., fading from a first level of brightness to a second level of brightness). In some embodiments, combinations of the foregoing may be employed (e.g., combining animation with levels of transparency and changing levels of brightness).

UI 500L-UI 500N (FIGS. 5L-5N) illustrate a fourth control adjustment gesture in accordance with some embodiments.

UI 500L (FIG. 5L) illustrates a user gesture 578 (not drawn to scale in the figure) that makes a finger contact 580 at a first location 582 on touch screen 112. The first location 582 and an edge of touch screen 112 define a first distance 584 on one side of the first location 582. Further, the adjustable parameter's current setting is used to establish a second distance 586 on the opposite side of the first location 582, where: (1) the initial point of contact of a control adjustment gesture (e.g., first location 582) corresponds to the current setting within the range of values that the adjustable parameter can be set to; and (2) the combination of the first and second distances correspond to the full range of values for the adjustable parameter. In other words, the sum of the first distance 584 and the second distance 586 corresponds to the range of values the adjustable parameter can be set to during the control adjustment gesture. For example, in UI 500L, before the beginning of user gesture 578, an adjustable parameter was set to 80%. So, when the user gesture 578 comes into contact with the touch screen 112 at the first location 582, the first location 582 corresponds to the location within the full range of the first distance 584 and the second distance 586 that would set the adjustable parameter to 80%.

In the example of UI 500L, the setting indicia 588 is set to the 80% level on visual indicator 589.

UI 500M (FIG. 5M) illustrates that the finger contact 580 of user's finger gesture 578 has moved to a second location 590 on touch screen 112, where the second location 590 is within first distance 584. Accordingly, the setting indicia 588 of visual indicator 589 has moved to a second position on visual indicator 589 in accordance with the movement of the finger contact 580, which in this example, reflects that the adjustable parameter is now set at 50%.

UI 500N (FIG. 5N) illustrates that the finger contact 580 of user's finger gesture 578 has moved to a third location 592 on touch screen 112, where the third location 592 is within second distance 586. Accordingly, the setting indicia 588 of visual indicator 589 has moved to a third position on visual indicator 589 in accordance with the movement of the finger contact 580, which in this example, reflects that the adjustable parameter is now set at 85%.

FIGS. 6A-6B are flow diagrams illustrating a method of adjusting a playback control with a finger gesture in accordance with some embodiments. The method 600 is performed at an electronic device, which in some embodiments may be a multifunction device (e.g., device 100, FIG. 2) with a display and a touch-sensitive surface. Some operations in method 600 may be combined and/or the order of some operations may be changed.

In some embodiments, the method is performed by a portable multifunction device with a touch screen display (e.g., portable multifunction device 100 in FIG. 2). In these embodiments, the aforementioned touch-sensitive surface part of the device's display. In other words, the multifunction device's display is a touch screen display (e.g., display 112, FIG. 2).

As described below, the method 600 provides an intuitive way to efficiently adjust a playback control on an electronic device. The method reduces the cognitive burden on a user when adjusting parameters, thereby creating a more efficient human-machine interface. For battery-operated computing devices, enabling a user to adjust parameters more quickly and efficiently conserves power and increases the time between battery charges.

The method 600 is performed while providing content with the electronic device (e.g., with the video and music player application 152). The device detects (602) a finger contact (e.g., 502, FIG. 5A) at a first location (e.g., 503, FIG. 5A) on the touch-sensitive surface. The first location and a first edge of the touch-sensitive surface define a first distance (e.g., 504, FIG. 5A). The finger contact at the first location corresponds to a start of a control adjustment gesture operable to set an adjustable parameter for providing content with the electronic device. The adjustable parameter is configured to be set to a position within a range of positions.

In response to detecting the start of the control adjustment gesture at the first location, the device maps (604) the range of positions associated with the adjustable parameter to correspond to at least a portion of the first distance (e.g., 504, FIG. 5A). In some embodiments, the device dynamically maps the range of positions associated with the adjustable parameter to correspond to at least a portion of the first distance.

In some embodiments, the first distance is mapped to the full range of positions the adjustable parameter can be set to. For example, when a user starts a control adjustment gesture at a first location on the touch-sensitive surface, the distance from the first location to the edge of the touch-sensitive surface (i.e., the first distance) will correspond to the full range of positions for the adjustable parameter. For example, if the first location is 1 inch from the touch-sensitive surface's edge, and the adjustable parameter is a volume control where the volume is initially set to 100% or a maximum setting, a control adjustment gesture of ½ of an inch toward the touch-sensitive surface's edge will turn the volume down to 50%. (see, e.g., UI 500A-UI 500B, where FIG. 5A depicts the first location 503 which defines the first distance 504 when the value of the adjustable parameter being modified is at 100%, and FIG. 5B depicts that finger gesture 501 has moved down half of the first distance 504, so the adjustable parameter has been adjusted from 100% to 50%.) In this example, a control adjustment gesture of a full inch, i.e., moving all the way from the first location to the first edge of the touch-sensitive surface, will adjust the volume from the maximum 100% value to zero or a minimum value. (See, e.g., UI 500A-UI 500C, where FIG. 5A depicts the first location 503 which defines the first distance 504 when the value of the adjustable parameter being modified is at 100%, and FIG. 5C depicts that finger gesture 501 has moved down the entire length of the first distance 504 to the edge of touch screen 112, so the adjustable parameter has been adjusted from 100% to 0%.)

In some embodiments, the first distance is mapped to a subset of the range of positions the adjustable parameter can be set to, taking into account the adjustable parameter's initial setting and the type of control adjustment gesture. For example, if a volume control is initially set to 50% volume before a volume decrease gesture is detected, the first distance would be mapped to the lower half of the range of positions the volume parameter could be set to (see, e.g., UI 500E-UI 500G, where FIG. 5E depicts that the first distance 536 is mapped to the range 50% to 0% when the adjustable parameter being adjusted was initially set to 50% when a volume decrease gesture began, and FIG. 5G illustrates that in accordance with the movement of the finger contact 532, the adjustable volume parameter is set to 5%.)

In alternate embodiments, the first distance is mapped to a first subset of the range of settings for the adjustable parameter, taking into account the adjustable parameter's initial setting and the type of control adjustment gesture detected. Further, the initial setting of the adjustable parameter is used to establish a second distance on the opposite side of the first contact location of the control adjustment gesture, where the second distance is mapped to a second subset of the range of settings for the adjustable parameter (see, e.g., UI 500L first distance 584 that is below the first location 582, and second distance 586 that is above the first location 582, and the first location 582, which corresponds to the initial setting of 80% for the adjustable parameter).

For example, as depicted in UI 500L, if the volume is initially set at 80% of maximum, and a volume adjustment gesture is detected: (1) the first distance is mapped to a first subset of the range of volume settings, namely minimum to 80% (see, e.g., UI 500L first distance 584); (2) the second distance is mapped to a second subset of the range of volume settings, namely 80% to maximum (see, e.g., UI 500L second distance 586); and (3) the location of the first contact is automatically set to the 80% value within the range of volume settings (see, e.g., UI 500L finger contact 580 at first location 582). Thus, the initial point of contact of a control adjustment gesture establishes both a first and a second distance on the touch screen, and the combination of the first and second distances correspond to the full range of values that an adjustable parameter can be set to during a control adjustment gesture. The initial point of contact of the control adjustment gesture corresponds to the initial setting of the adjustable parameter before the control adjustment gesture began.

In some embodiments, the device outputs (606) an audio indicia identifying the adjustable parameter for providing content (e.g. “volume,” “bass,” “treble,” “balance,” etc.).

The device detects (608) movement of the finger contact in the control adjustment gesture (e.g., see contact 502 in FIGS. 5B-5D). The device modifies (610) the adjustable parameter for providing content in accordance with the movement of the finger contact in the control adjustment gesture, and in accordance with the mapped range of positions associated with the adjustable parameter that correspond to the first distance. For example, as the finger contact 502 moves during the control adjustment gesture 501, the adjustable parameter is adjusted up or down as the finger contact moves up or down on the touch-sensitive display (see, e.g., the description of FIGS. 5A-5D above).

In some embodiments, the device outputs (612) an audio indicia corresponding to a current setting of the adjustable parameter for providing content. For example, during a volume adjustment gesture 501, the device may output the current setting of the parameter being adjusted, e.g., “10% volume”, “50% volume”, or “maximum volume.”

In some embodiments, the touch-sensitive surface is separate from the display. For example, in some embodiments, the touch-sensitive surface is a touch pad that is a component of the electronic device, but the touch-sensitive surface is separate from the display.

In some embodiments, the touch-sensitive surface is a part of a touch screen display (614) (e.g., touch screen 112).

In some embodiments, the device displays (616) a visual indicator on the touch screen display in response to detecting the start of the control adjustment gesture at the first location (e.g., 515 and 517, FIG. 5B). While modifying the adjustable parameter for providing content in accordance with the movement of the finger contact, the device adjusts the visual indicator in accordance with the movement of the finger contact (see, e.g., 515 and 517 in FIGS. 5B-5D). The device terminates display of the visual indicator after the control adjustment gesture. In some embodiments, the device terminates display of the visual indicator at an end of the control adjustment gesture.

In some embodiments, the device reduces (618) finger occlusion of the visual indicator by dynamically moving the visual control during the control adjustment gesture (see, e.g. moving the visual indicator 538 in FIG. 5E to a new position in FIG. 5F).

In some embodiments, when the device displays a visual indicator, it places (620) the visual indicator on the touch-sensitive display at a distance from the finger contact at the first location, such that the placement of the visual indicator avoids finger occlusion of the visual indicator during the control adjustment gesture (see, e.g., the placement in FIG. 5A of visual indicator 515 in relation to user's finger gesture 501). As noted above, the operations of reducing occlusion (618) and placing the visual indicator (620) are not mutually exclusive, and they may be used together.

In some embodiments, the control adjustment gesture is configured to modify the adjustable parameter for providing content irrespective of the orientation of the control adjustment gesture on the touch-sensitive surface (622). (e.g., compare the orientation of the control adjustment gestures in FIGS. 5A-5D with that in FIGS. 5H-5I).

In some embodiments, modifying the adjustable parameter for providing content further comprises adjusting the parameter in accordance with the velocity of the movement of the finger contact in the control adjustment gesture. In some embodiments, modifying the adjustable parameter for providing content further comprises adjusting the parameter in accordance with the acceleration of the movement of the finger contact in the control adjustment gesture.

The steps in the information processing methods described above may be implemented by running one or more functional modules in information processing apparatus such as general purpose processors or application specific chips. These modules, combinations of these modules, and/or their combination with general hardware (e.g., as described above with respect to FIGS. 1A, 1B and 3) are all included within the scope of protection of the invention.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
at an electronic device with a touch-sensitive surface:
while providing content with the electronic device:
detecting a finger contact at a first location on the touch-sensitive surface, wherein:
the first location and a first edge of the touch-sensitive surface define a first distance,
the finger contact at the first location corresponds to a start of a control adjustment gesture operable to set an adjustable parameter for providing content with the electronic device, and
the adjustable parameter is configured to be set to a position within a range of positions;
in response to detecting the start of the control adjustment gesture at the first location, mapping the range of positions associated with the adjustable parameter to correspond to at least a portion of the first distance;
detecting movement of the finger contact in the control adjustment gesture; and
modifying the adjustable parameter for providing content in accordance with the movement of the finger contact in the control adjustment gesture and in accordance with the mapped range of positions associated with the adjustable parameter that correspond to the first distance.

2. The method of claim 1, wherein the touch-sensitive surface is a part of a touch screen display.

3. The method of claim 2, further comprising:
displaying a visual indicator on the touch screen display in response to detecting the start of the control adjustment gesture at the first location;
while modifying the adjustable parameter for providing content in accordance with the movement of the finger contact, adjusting the visual indicator in accordance with the movement of the finger contact; and
terminating display of the visual indicator after the control adjustment gesture ends.

4. The method of claim 3, further comprising reducing finger occlusion of the visual indicator by dynamically moving the visual indicator during the control adjustment gesture.

5. The method of claim 3, wherein displaying the visual indicator on the touch screen display includes placing the visual indicator on the touch screen display at a distance from the finger contact at the first location such that the placement of the visual indicator avoids finger occlusion of the visual indicator during the control adjustment gesture.

6. The method of claim 1, further comprising outputting an audio indicia identifying the adjustable parameter for providing content during the control adjustment gesture.

7. The method of claim 1, further comprising outputting an audio indicia corresponding to a current setting of the adjustable parameter for providing content during the control adjustment gesture.

8. The method of claim 1, wherein the control adjustment gesture is configured to modify the adjustable parameter for providing content irrespective of an orientation of the control adjustment gesture on the touch-sensitive surface.

9. An electronic device, comprising:
a touch-sensitive surface;
one or more processors;
memory; and
one or more programs, wherein the one or more programs are stored in the memory and configured to be executed by the one or more processors while providing content at the electronic device, the one or more programs including instructions for:
while providing content with the electronic device:
detecting a finger contact at a first location on the touch-sensitive surface, wherein:
the first location and a first edge of the touch-sensitive surface defines a first distance,
the finger contact at the first location corresponds to a start of a control adjustment gesture operable to set an adjustable parameter for providing content with the electronic device, and
the adjustable parameter is configured to be set to a position within a range of positions;
mapping the range of positions associated with the adjustable parameter to correspond to the first distance in response to detecting the start of the control adjustment gesture at the first location;
detecting movement of the finger contact in the control adjustment gesture; and
modifying the adjustable parameter for providing content in accordance with the movement of the finger contact in the control adjustment gesture and in accordance with the mapped range of positions associated with the adjustable parameter that correspond to the first distance.

10. A computer readable storage medium having stored therein instructions, which when executed by an electronic device with a touch-sensitive surface, cause the electronic device to:
while providing content with the electronic device:
detect a finger contact at a first location on the touch-sensitive surface, wherein:
the first location and a first edge of the touch-sensitive surface defines a first distance,
the finger contact at the first location corresponds to a start of a control adjustment gesture operable to set an adjustable parameter for providing content with the electronic device, and
the adjustable parameter is configured to be set to a position within a range of positions;
map the range of positions associated with the adjustable parameter to correspond to the first distance in response to detecting the start of the control adjustment gesture at the first location;
detect movement of the finger contact in the control adjustment gesture; and modify the adjustable parameter for providing content in accordance with the movement of the finger contact in the control adjustment gesture and in accordance with the mapped range of positions associated with the adjustable parameter that correspond to the first distance.

11. An electronic device, comprising:
a touch-sensitive surface;
means for providing content;
while providing content with the electronic device:
means for detecting a finger contact at a first location on the touch-sensitive surface, wherein:
the first location and a first edge of the touch-sensitive surface defines a first distance,
the finger contact at the first location corresponds to a start of a control adjustment gesture operable to set an adjustable parameter for providing content with the electronic device, and
the adjustable parameter is configured to be set to a position within a range of positions;
means for mapping the range of positions associated with the adjustable parameter to correspond to the first distance in response to detecting the start of the control adjustment gesture at the first location;
means for detecting movement of the finger contact in the control adjustment gesture; and
means for modifying the adjustable parameter for providing content in accordance with the movement of the finger contact in the control adjustment gesture and in accordance with the mapped range of positions associated with the adjustable parameter that correspond to the first distance.
